(19) United States
(12) Patent Application Publication
(10) Pub. No.: US 2026/0269517 A1
(43) Pub. Date: Sep. 10, 2026

(54) ELECTRICAL CONNECTOR WITH THROUGH GROOVE FOR HEAT DISTRIBUTION

(71) Applicant: DONGGUAN LUXSHARE TECHNOLOGIES CO., LTD, Dongguan City (CN)

(72) Inventors: Hengshan CHENG, Dongguan City (CN); Chuanqi GONG, Dongguan City (CN); Hongji CHEN, Dongguan City (CN); Xiongwei WU, Dongguan City (CN)

(73) Assignee: DONGGUAN LUXSHARE TECHNOLOGIES CO., LTD, Dongguan City (CN)

(21) Appl. No.: 19/327,875

(22) Filed: Sep. 12, 2025

(30) Foreign Application Priority Data
Mar. 7, 2025 (CN) 202520403931.X

(51) Int. Cl. H01R 13/533; H01R 12/70; H01R 13/6581

(52) U.S. Cl. CPC H01R 13/533; H01R 12/707; H01R 13/6581

(57) ABSTRACT

An electrical connector includes a mounting frame, a shielding assembly and a terminal module. The shielding assembly includes a first shielding plate assembly, a second shielding plate assembly, a third shielding plate assembly and a fourth shielding plate assembly. The first shielding plate assembly and the second shielding plate assembly are mated with the third shielding plate assembly and the fourth shielding plate assembly to form a number of shielding units. Each shielding unit includes an accommodating space to receive the terminal module. The terminal module includes an insulating block. The insulating block includes a first through groove in communication with the accommodating space.

### CROSS-REFERENCE TO RELATED APPLICATION

This patent application claims priority of a Chinese Patent Application No. 202520403931.X, filed on Mar. 7, 2025 and titled “FIRST ELECTRICAL CONNECTOR”, the entire content of which is incorporated herein by reference.

### TECHNICAL FIELD

The present disclosure relates to an electrical connector, which belongs to the field of connector technology.

### BACKGROUND

A first electrical connector in the related art generally includes an insulating body, a plurality of conductive terminals and a shielding shell. When the first electrical connector is soldered to a circuit board and the first electrical connector is in operation, its reliability is easily affected due to poor heat dissipation.

### SUMMARY

The present disclosure discloses an electrical connector, including: a mounting frame, the mounting frame defining a mounting space; a shielding assembly, the shielding assembly being at least partially disposed in the mounting space; the shielding assembly including a first shielding plate assembly, a second shielding plate assembly, a third shielding plate assembly and a fourth shielding plate assembly; the first shielding plate assembly and the second shielding plate assembly being disposed at intervals in a second direction; the third shielding plate assembly and the fourth shielding plate assembly being disposed at intervals in a third direction; the first shielding plate assembly and the second shielding plate assembly being mated with the third shielding plate assembly and the fourth shielding plate assembly to form a plurality of shielding units; each shielding unit including an accommodating space extending in a first direction; each two of the first direction, the second direction and the third direction being perpendicular to each other; and a terminal module, the terminal module being received in the accommodating space; the terminal module including an insulating block which includes a top surface, a bottom surface, and a first through groove extending through the top surface and the bottom surface; the first through groove being in communication with the accommodating space.

The present disclosure discloses an electrical connector, including: a mounting frame; a shielding assembly, the shielding assembly being at least partially mounted to the mounting frame; the shielding assembly including a first shielding plate assembly, a second shielding plate assembly, a third shielding plate assembly and a fourth shielding plate assembly; the first shielding plate assembly and the second shielding plate assembly being disposed at intervals in a second direction; the third shielding plate assembly and the fourth shielding plate assembly being disposed at intervals in a third direction; the first shielding plate assembly and the second shielding plate assembly being mated with the third shielding plate assembly and the fourth shielding plate assembly to form a plurality of shielding units; each shielding unit including an accommodating space extending in a first direction; each two of the first direction, the second direction and the third direction being perpendicular to each other; and a terminal module, the terminal module being received in the accommodating space; the terminal module including an insulating block which includes a first surface, a second surface disposed opposite to the first surface, and a first through groove extending through the first surface and the second surface along the first direction; the first through groove being in communication with the accommodating space.

### BRIEF DESCRIPTION OF DRAWINGS

FIG. 1 is a perspective schematic view of a connector assembly in accordance with an embodiment of the present disclosure;

FIG. 2 is a perspective view of FIG. 1 from another angle;

FIG. 3 is a partially exploded view of FIG. 1;

FIG. 4 is a perspective exploded view of a first electrical connector, a circuit board and a plurality of fasteners in FIG. 3;

FIG. 5 is a partial enlarged view of circle part B in FIG. 4;

FIG. 6 is a perspective exploded view of FIG. 4 from another angle;

FIG. 7 is a partial enlarged view of circle part C in FIG. 6;

FIG. 8 is a top view of the first electrical connector and the circuit board in FIG. 4 when they are separated from each other;

FIG. 9 is a partial enlarged view of frame part D in FIG. 8;

FIG. 10 is a partial enlarged view of frame part E in FIG. 8;

FIG. 11 is a bottom view of FIG. 8;

FIG. 12 is a partial enlarged view of frame part F in FIG. 11;

FIG. 13 is a partially exploded view of the first electrical connector in FIG. 4;

FIG. 14 is a partially exploded view of FIG. 13 from another angle;

FIG. 15 is a top view of a mounting frame, a shielding assembly and a plurality of terminal modules in FIG. 13;

FIG. 16 is a bottom view of FIG. 15;

FIG. 17 is a partially exploded view of the shielding assembly and the plurality of terminal modules in FIG. 13, wherein a first shielding plate assembly, a second shielding plate assembly, a third shielding plate assembly and a fourth shielding plate assembly are separated;

FIG. 18 is a partially exploded view of FIG. 17 from another angle;

FIG. 19 is a further partially exploded view of FIG. 17, wherein the first shielding plate assembly, the second shielding plate assembly, the third shielding plate assembly and the fourth shielding plate assembly are respectively exploded;

FIG. 20 is a partial enlarged view of frame part G in FIG. 19 in accordance with a first embodiment of the present disclosure;

FIG. 21 is a partial enlarged view of frame part G in FIG. 19 in accordance with a second embodiment of the present disclosure;

FIG. 22 is a partial enlarged view of frame part G in FIG. 19 in accordance with a third embodiment of the present disclosure;

FIG. 23 is a schematic cross-sectional view of the first shielding plate assembly in one embodiment taken along a certain cross-section;

FIG. 24 is a schematic cross-sectional view of the first shielding plate assembly in another embodiment taken along a certain cross-section;

FIG. 25 is a partial enlarged view of frame portion H in FIG. 19 in accordance with an embodiment of the present disclosure;

FIG. 26 is a partial enlarged view of frame portion I in FIG. 19 in accordance with another embodiment of the present disclosure;

FIG. 27 is a partial enlarged view of frame portion J in FIG. 19 in accordance with yet another embodiment of the present disclosure;

FIG. 28 is a perspective schematic view of a terminal module in FIG. 19;

FIG. 29 is a perspective schematic view of FIG. 28 from another angle;

FIG. 30 is a perspective exploded view of FIG. 28;

FIG. 31 is a perspective exploded view of FIG. 30 from another angle;

FIG. 32 is a cross-sectional view taken along line M-M in FIG. 8;

FIG. 33 is a cross-sectional view taken along line N-N in FIG. 8;

FIG. 34 is a partial enlarged view of frame part K in FIG. 32;

FIG. 35 is a partial enlarged view of frame part L in FIG. 33; and

FIG. 36 is a perspective schematic view of a second electrical connector in FIG. 3 from another angle.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

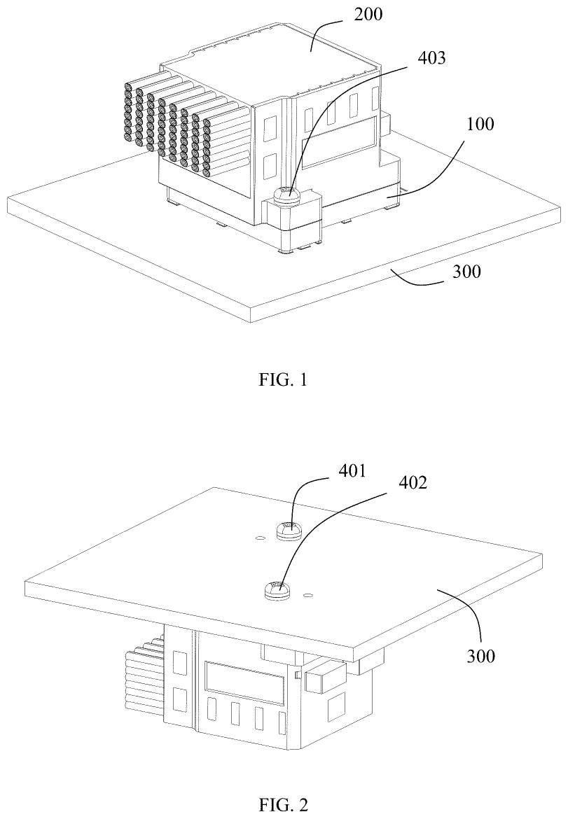

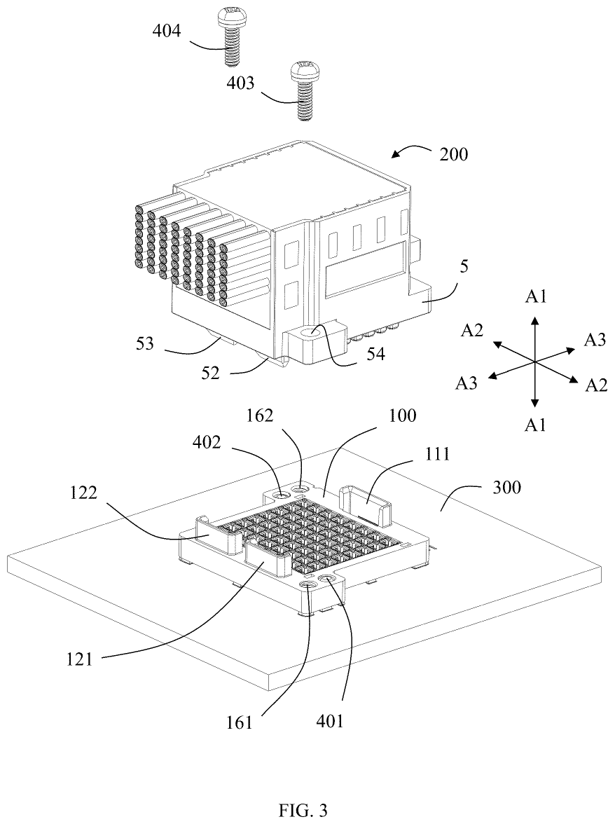

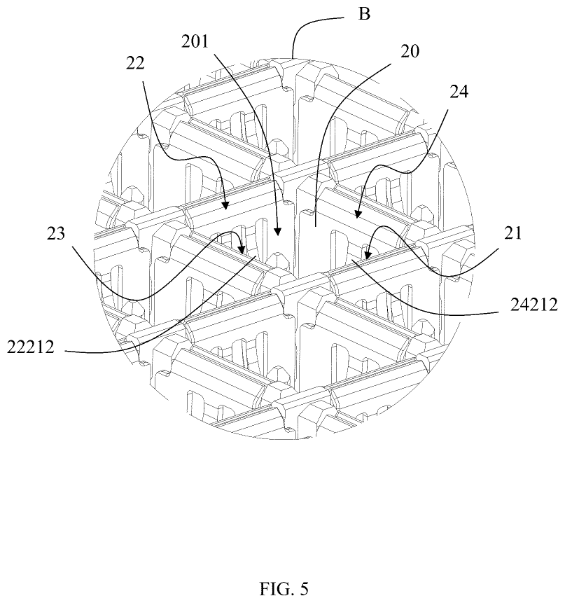

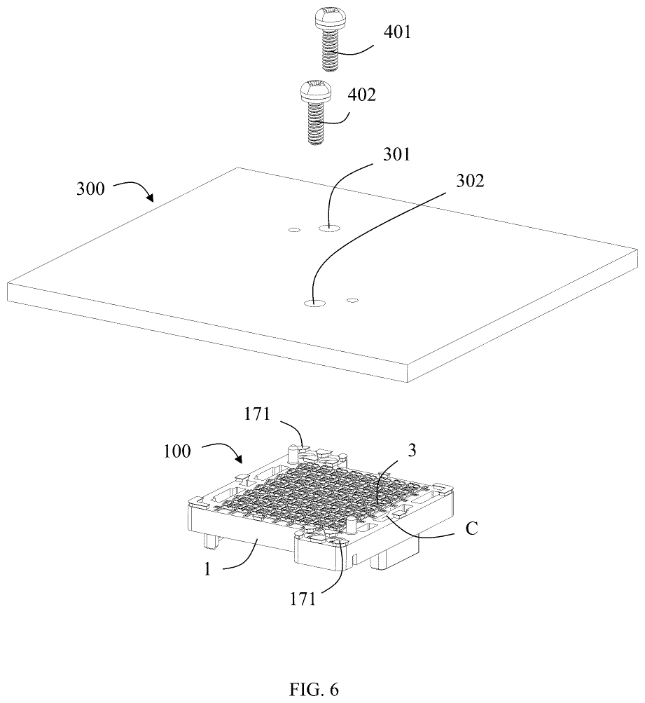

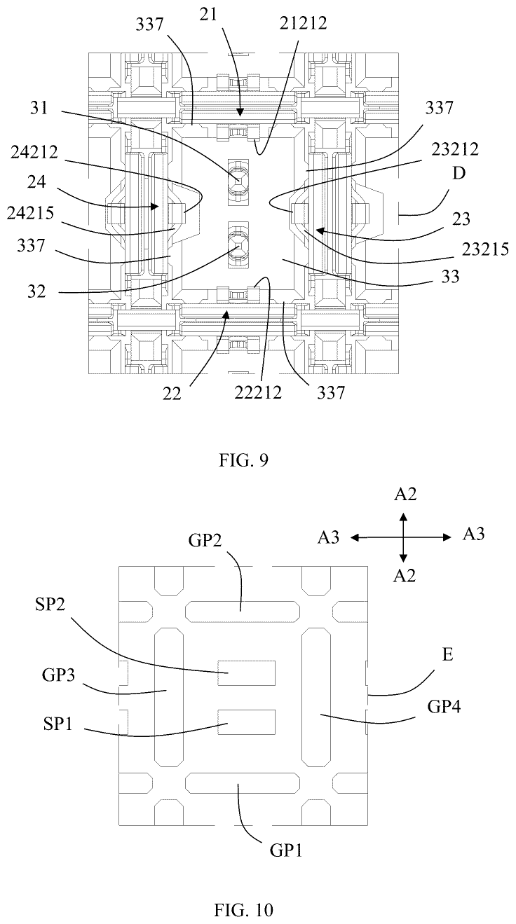

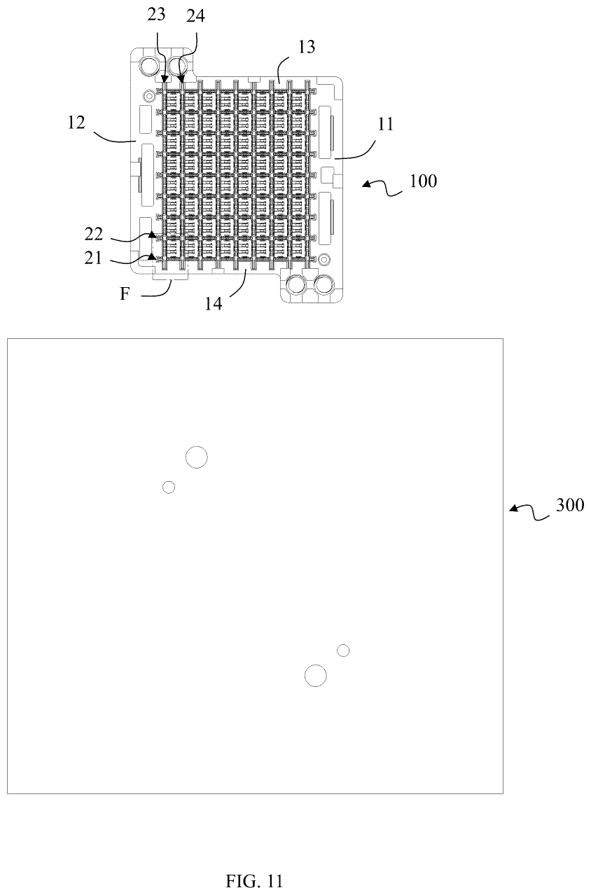

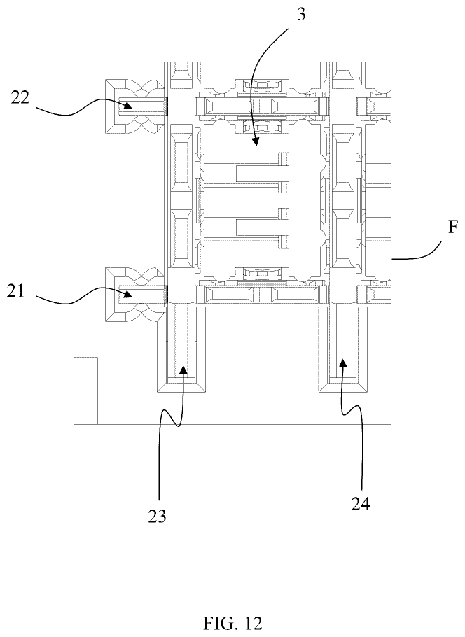

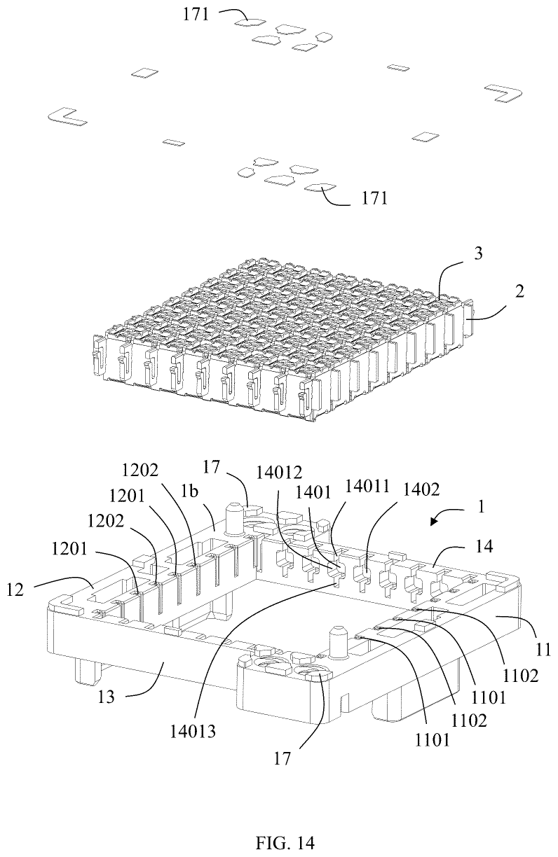

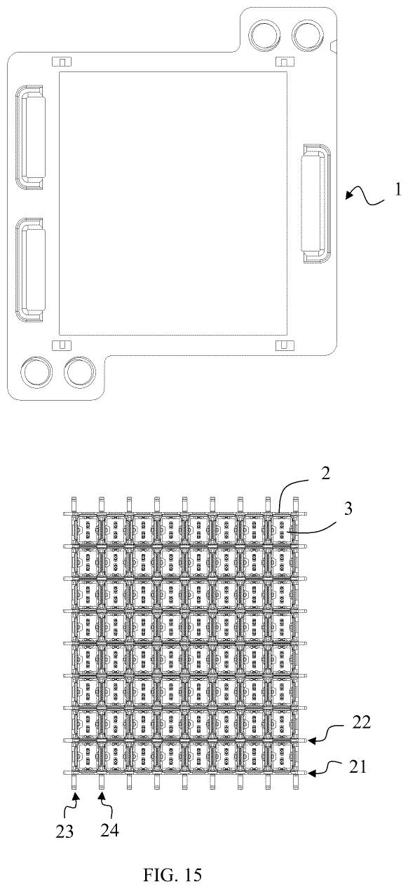

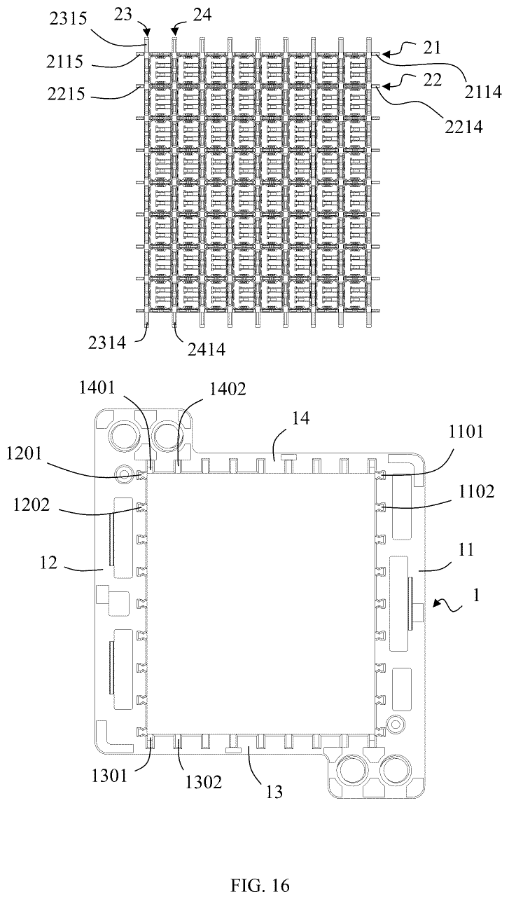

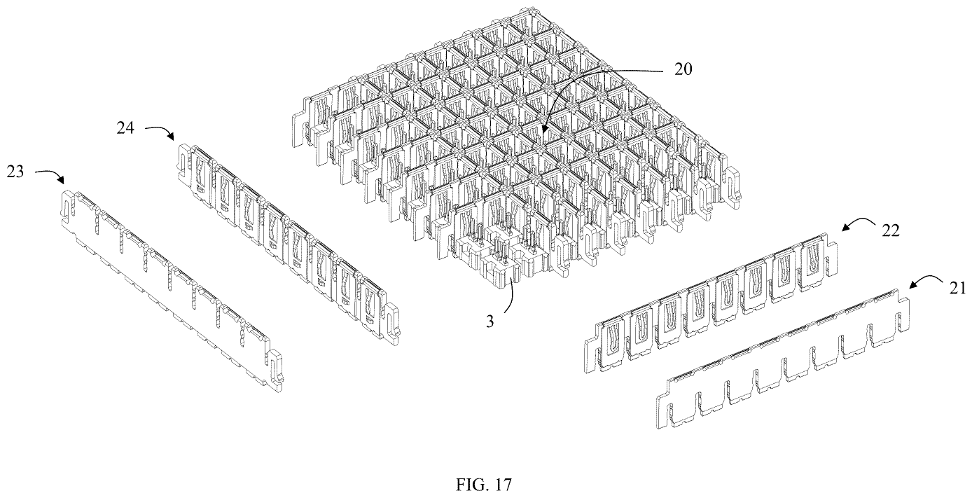

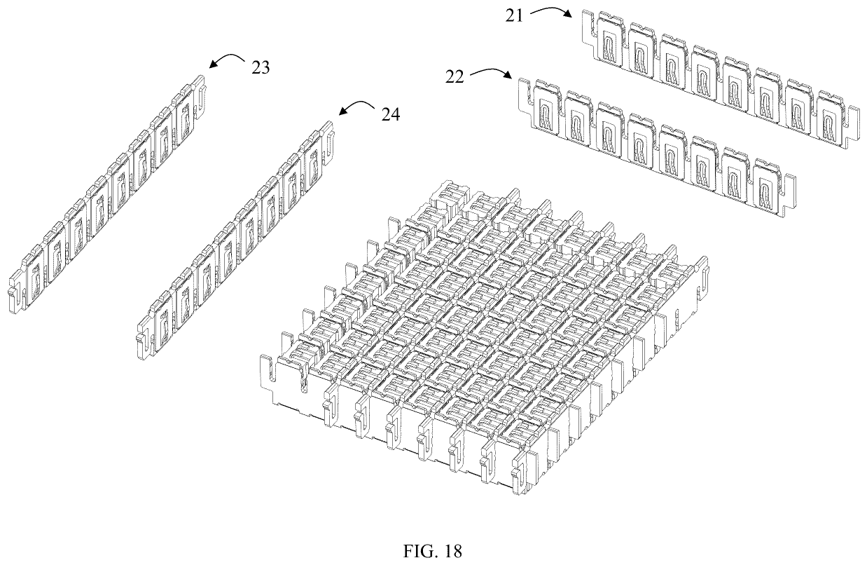

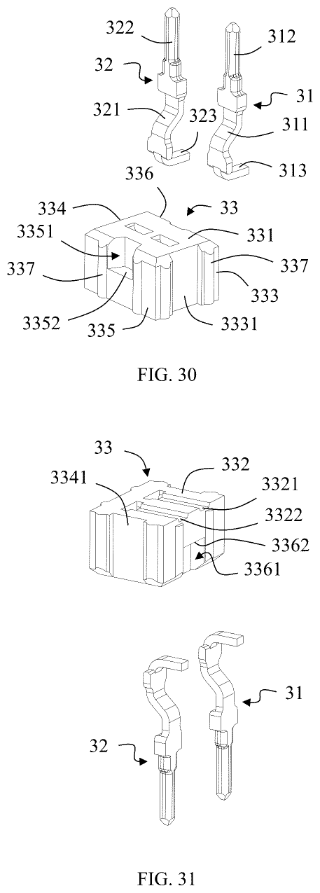

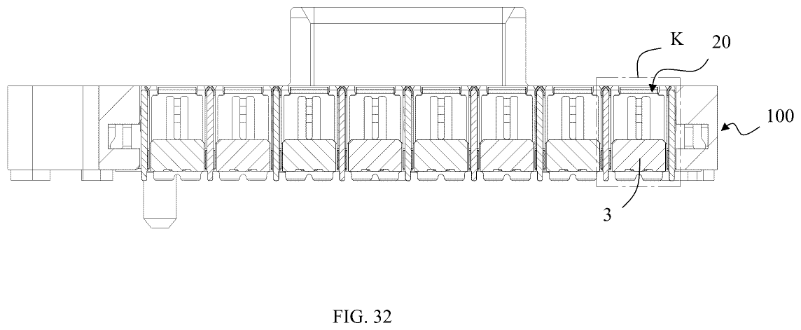

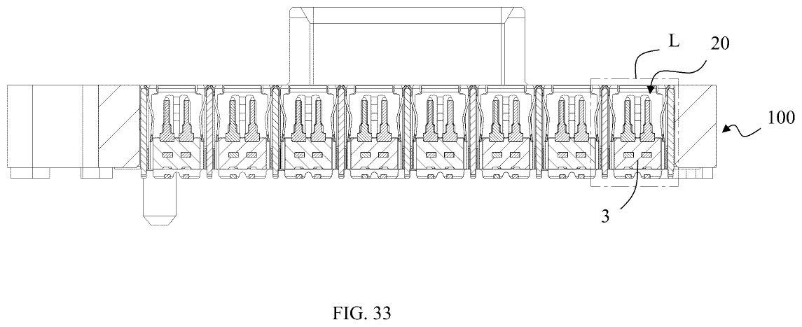

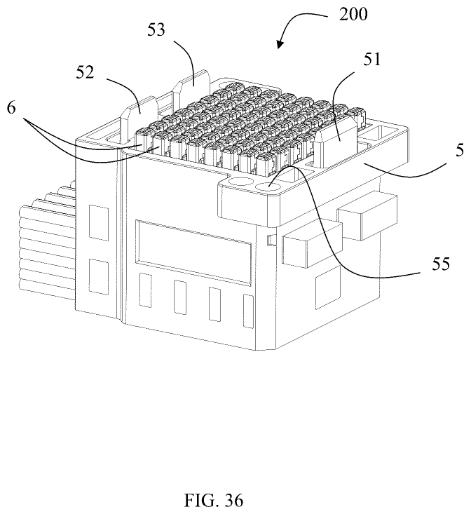

Referring to FIG. 1 to FIG. 36, the present disclosure discloses a connector assembly, including a circuit board 300, a first electrical connector 100 mounted to the circuit board 300, and a second electrical connector 200 configured to mate with the first electrical connector 100. In the illustrated embodiment of the present disclosure, the first electrical connector 100 is a board-end backplane connector, and the second electrical connector 200 is a cable-end backplane connector. Of course, it is understandable to those skilled in the art that in other embodiments of the present disclosure, the types of the first electrical connector 100 and the second electrical connector 200 may be flexibly adjusted as needed. The second electrical connector 200 mates with the first electrical connector 100 along a mating direction to achieve data transmission.

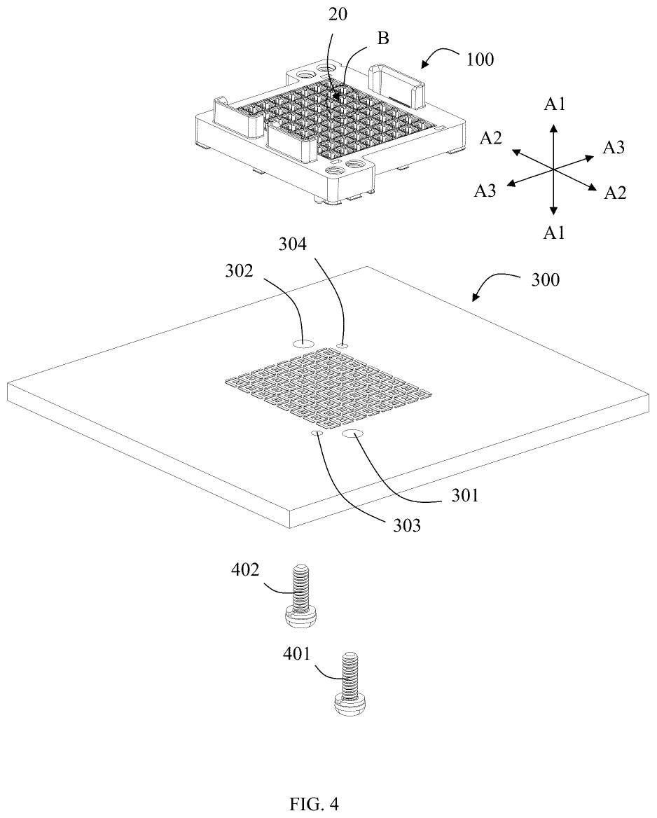

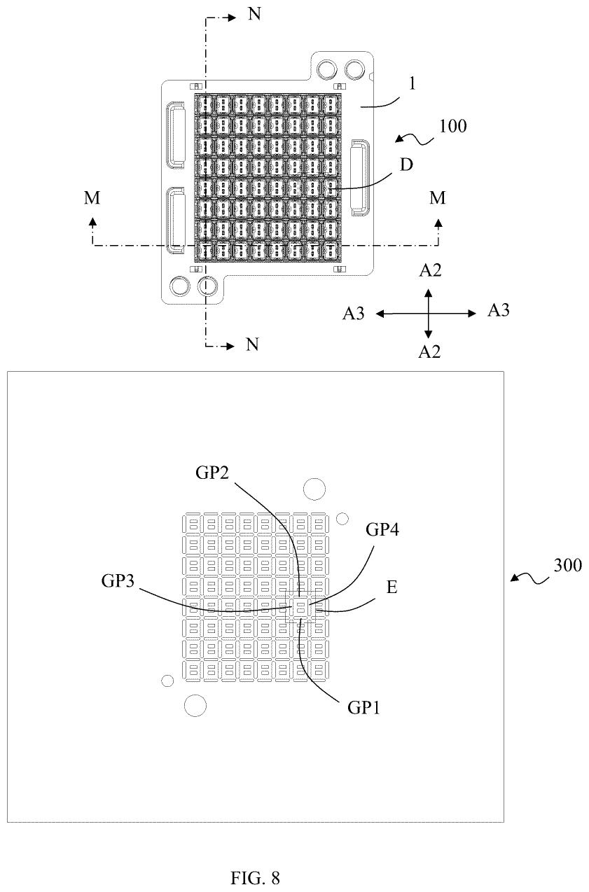

Referring to FIG. 4, FIG. 8 and FIG. 10, the circuit board 300 includes a plurality of conductive pads located on its surface (for example, an upper surface). The plurality of conductive pads are divided into several groups and are arranged in a matrix in a second direction A2-A2 (for example, a left-right direction) and a third direction A3-A3 (for example, a front-rear direction). Each group of conductive pads includes a first ground conductive pad GP1, a second ground conductive pad GP2, a third ground conductive pad GP3, a fourth ground conductive pad GP4, a first signal conductive pad SP1, and a second signal conductive pad SP2. In the illustrated embodiment of the present disclosure, the first ground conductive pad GP1, the second ground conductive pad GP2, the third ground conductive pad GP3 and the fourth ground conductive pad GP4 are generally enclosed to form a frame. Any two adjacent ground conductive pads of the first ground conductive pad GP1, the second ground conductive pad GP2, the third ground conductive pad GP3 and the fourth ground conductive pad GP4 are all arranged separately. That is, any two adjacent ground conductive pads of the first ground conductive pad GP1, the second ground conductive pad GP2, the third ground conductive pad GP3 and the fourth ground conductive pad GP4 are disconnected. The first signal conductive pad SP1 and the second signal conductive pad SP2 are located in the frame and are surrounded by the first ground conductive pad GP1, the second ground conductive pad GP2, the third ground conductive pad GP3 and the fourth ground conductive pad GP4 in order to improve the shielding effect and improve the quality of signal transmission. In one embodiment of the present disclosure, the first signal conductive pad SP1 and the second signal conductive pad SP2 form a differential pair to increase the rate of signal transmission. In the illustrated embodiment of the present disclosure, the two adjacent groups of conductive pads share one ground conductive pad. As for any group of first signal conductive pad SP1 and second signal conductive pad SP2, one first ground conductive pad GP1, one second ground conductive pad GP2, one third ground conductive pad GP3 and one fourth ground conductive pad GP4 are provided around them to ensure a good shielding effect.

Besides, the circuit board 300 further includes a first mounting through hole 301, a second mounting through hole 302, a first positioning hole 303 and a second positioning hole 304. In the illustrated embodiment of the present disclosure, the first mounting through hole 301, the second mounting through hole 302, the first positioning hole 303 and the second positioning hole 304 all extend through the circuit board 300 in a thickness direction of the circuit board 300. The first mounting through hole 301, the second mounting through hole 302, the first positioning hole 303 and the second positioning hole 304 are all located outside the conductive pads.

Referring to FIG. 2 and FIG. 4, in the illustrated embodiment of the present disclosure, the connector assembly includes a plurality of fasteners that secure the first electrical connector 100 to the circuit board 300. The fasteners include a first screw 401 and a second screw 402. The first screw 401 passes through the first mounting through hole 301 and is fixed in the first electrical connector 100. The second screw 402 passes through the second mounting through hole 302 and is fixed in the first electrical connector 100.

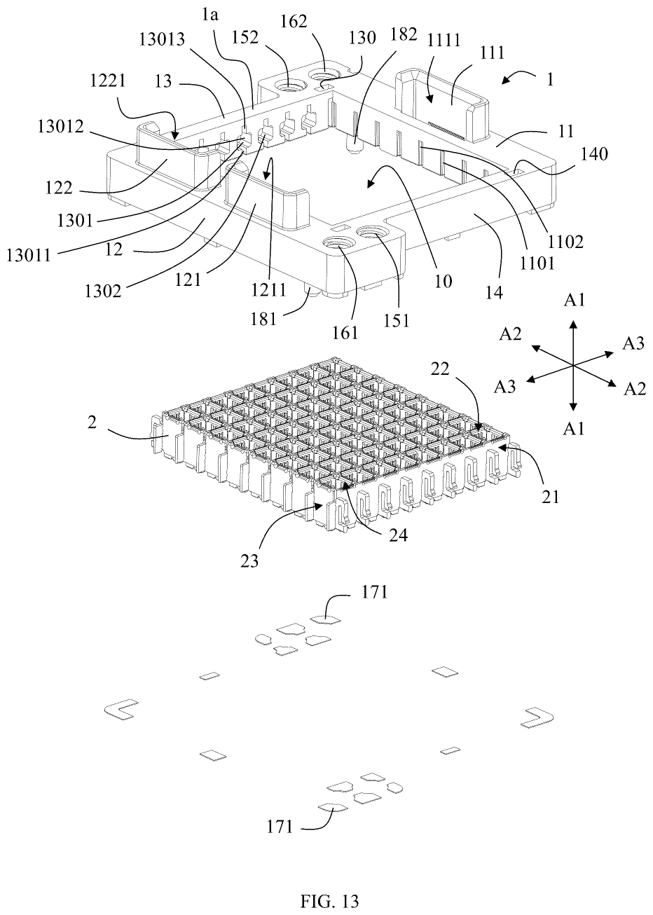

Referring to FIG. 13 to FIG. 35, in the illustrated embodiment of the present disclosure, the first electrical connector 100 includes a mounting frame 1, a shielding assembly 2 mounted to the mounting frame 1, and a plurality of terminal modules 3 mounted to the shielding assembly 2.

In one embodiment of the present disclosure, the mounting frame 1 is a conductive mounting frame. Specifically, in one embodiment of the present disclosure, the mounting frame 1 is a metal mounting frame. That is, the mounting frame 1 is made of a metal material so as to improve shielding performance. The mounting frame 1 includes a mating surface 1a (for example, an upper surface) and a mounting surface 1b (for example, a lower surface) disposed opposite to the mating surface 1a. The mounting frame 1 is roughly in a hollow rectangle shape, and includes a first wall portion 11, a second wall portion 12 disposed opposite to the first wall portion 11, a third wall portion 13 connecting one end of the first wall portion 11 and one end of the second wall portion 12, a fourth wall portion 14 connecting another end of the first wall portion 11 and another end of the second wall portion 12, and a mounting space 10 enclosed by the first wall portion 11, the second wall portion 12, the third wall portion 13 and the fourth wall portion 14.

In the illustrated embodiment of the present disclosure, the mounting frame 1 further includes a first positioning protrusion 111 that protrudes upwardly beyond the first wall portion 11 along the first direction A1-A1 (for example, a top-bottom direction). In the illustrated embodiment of the present disclosure, the first positioning protrusion 111 is integrally formed with the first wall portion 11 so as to increase structural strength. Specifically, in the illustrated embodiment of the present disclosure, the first positioning protrusion 111 is generally U-shaped, which includes a first guide groove 1111 that extends through the first wall portion 11 along the first direction A1-A1.

The mounting frame 1 further includes a second positioning protrusion 121 and a third positioning protrusion 122 which extend upwardly beyond the second wall portion 12 along the first direction A1-A1. In the illustrated embodiment of the present disclosure, the second positioning protrusion 121 and the third positioning protrusion 122 are arranged at intervals along the second direction A2-A2. In the illustrated embodiment of the present disclosure, the second positioning protrusion 121 and the third positioning protrusion 122 are both integrally formed with the second wall portion 12 in order to increase structural strength. Specifically, in the illustration embodiment of the present disclosure, the second positioning protrusion 121 is generally U-shaped, which includes a second guide groove 1211 extending through the second wall portion 12 along the first direction A1-A1. Similarly, the third positioning protrusion 122 is also generally U-shaped, which includes a third guide groove 1221 extending through the second wall portion 12 along the first direction A1-A1. It is understandable to those skilled in the art that by providing the first positioning protrusion 111 on the first wall portion 11, and by providing the second positioning protrusion 121 and the third positioning protrusion 122 on the second wall portion 12, The present disclosure can play a fool-proof role and ensure the correctness when mating with the second electrical connector 200.

In the illustrated embodiment of the present disclosure, the mounting frame 1 further includes a first fastening hole 151 and a first mounting hole 161 which are located at one corner thereof, and a second fastening hole 152 and a second mounting hole 162 which are located at another corner thereof. In the illustrated embodiment of the present disclosure, the corner where the first fastening hole 151 and the first mounting hole 161 are located and the corner where the second fastening hole 152 and the second mounting hole 162 are located are approximately two corners diagonally on the mounting frame 1. In the illustrated embodiment of the present disclosure, the first fastening hole 151, the second fastening hole 152, the first mounting hole 161 and the second mounting hole 162 are all threaded holes. When the mounting frame 1 is made of metal material, the threaded holes are provided to ensure the reliability of tightening, improve the convenience of installation, and help reduce the height. The first screw 401 passes through the first mounting through hole 301 and is fixed in the first fastening hole 151 of the first electrical connector 100. The second screw 402 passes through the second mounting through hole 302 and is fixed in the second fastening hole 152 of the first electrical connector 100. With this arrangement, the present disclosure is conducive to improving the mounting strength when fixing the first electrical connector 100 to the circuit board 300.

In the illustrated embodiment of the present disclosure, the mounting frame 1 further includes a plurality of mounting protrusions 17 that protrude downwardly from the mounting surface 1b along the first direction A1-A1. The mounting protrusions 17 are configured to be supported on the circuit board 300 so that gaps are formed between the mounting surface 1b and the upper surface of the circuit board 300 to facilitate heat dissipation. In the illustrated embodiment of the present disclosure, a plurality of films 171 are provided on the mounting protrusions 17. The films 171 are sandwiched between the mounting protrusions 17 and the circuit board 300 to reduce the risk of damaging the circuit board 300.

In the illustrated embodiment of the present disclosure, the mounting frame 1 further includes a first positioning post 181 and a second positioning post 182 that extend downwardly beyond the mounting surface 1b along the first direction A1-A1. The first positioning post 181 and the second positioning post 182 are used to be inserted into the first positioning hole 303 and the second positioning hole 304 of the circuit board 300, respectively.

Besides, the mounting frame 1 further includes a plurality of first escape holes 130 that extend through the third wall portion 13 along the first direction A1-A1, and a plurality of second escape holes 140 that extend through the fourth wall portion 14 along the first direction A1-A1. The first escape holes 130 and the second escape holes 140 are in communication with the gap to facilitate heat dissipation.

In the illustrated embodiment of the present disclosure, an inner side of the first wall portion 11 defines a plurality of first mounting grooves 1101 that extend downwardly through the mounting surface 1b along the first direction A1-A1, and a plurality of third mounting grooves 1102 that extend downwardly through the mounting surface 1b along the first direction A1-A1. The first mounting grooves 1101 and the third mounting grooves 1102 are exposed to the mounting space 10 and in communication with the mounting space 10. The first mounting grooves 1101 and the third mounting grooves 1102 are arranged alternately in the second direction A2-A2. Each of the first mounting grooves 1101 and each of the third mounting grooves 1102 do not extend upwardly through the mating surface 1a along the first direction A1-A1, so as to ensure the structural strength of the first wall portion 11 as much as possible.

Similarly, an inner side of the second wall portion 12 defines a plurality of second mounting grooves 1201 that extend downwardly through the mounting surface 1b along the first direction A1-A1, and a plurality of fourth mounting grooves 1202 that extend downwardly through the mounting surface 1b along the first direction A1-A1. The second mounting grooves 1201 and the fourth mounting grooves 1202 are exposed to the mounting space 10 and in communication with the mounting space 10. The second mounting grooves 1201 and the fourth mounting grooves 1202 are arranged alternately in the second direction A2-A2. Each of the second mounting grooves 1201 and each of the fourth mounting grooves 1202 do not extend upwardly through the mating surface 1a along the first direction A1-A1, so as to ensure the structural strength of the second wall portion 12 as much as possible.

An inner side of the third wall portion 13 defines a plurality of fifth mounting grooves 1301 that extend downwardly through the mounting surface 1b along the first direction A1-A1, and a plurality of seventh mounting grooves 1302 that extend downwardly through the mounting surface 1b along the first direction A1-A1. The fifth mounting grooves 1301 and the seventh mounting grooves 1302 are exposed to the mounting space 10 and in communication with the mounting space 10. The fifth mounting grooves 1301 and the seventh mounting grooves 1302 are arranged alternately in the third direction A3-A3. Each of the fifth mounting grooves 1301 and each of the seventh mounting grooves 1302 do not extend upwardly through the mating surface 1a along the first direction A1-A1, so as to ensure the structural strength of the third wall portion 13 as much as possible. In the illustrated embodiment of the present disclosure, each of the fifth mounting grooves 1301 and each of the seventh mounting grooves 1302 include a first slit 13011 extending through the mounting surface 1b, a first flaring groove 13012 in communication with the first slit 13011, and a second slit 13013 in communication with the first flaring groove 13012. The first slit 13011, the first flaring groove 13012 and the second slit 13013 are arranged in sequence along the first direction A1-A1. That is, the first flaring groove 13012 is located between the first slit 13011 and the second slit 13013 in the first direction A1-A1. In the illustrated embodiment of the present disclosure, a width of the first flaring groove 13012 along the third direction A3-A3 is greater than a width of the first slit 13011 along the third direction A3-A3. The width of the first flaring groove 13012 along the third direction A3-A3 is greater than a width of the second slit 13013 along the third direction A3-A3.

Similarly, an inner side of the fourth wall portion 14 defines a plurality of sixth mounting grooves 1401 that extend downwardly through the mounting surface 1b along the first direction A1-A1, and a plurality of eighth mounting grooves 1402 that extend downwardly through the mounting surface 1b along the first direction A1-A1. The sixth mounting grooves 1401 and the eighth mounting grooves 1402 are exposed to the mounting space 10 and in communication with the mounting space 10. The sixth mounting grooves 1401 and the eighth mounting grooves 1402 are arranged alternately in the third direction A3-A3. Each of the sixth mounting grooves 1401 and each of the eighth mounting grooves 1402 do not extend upwardly through the mating surface 1a along the first direction A1-A1, so as to ensure the structural strength of the fourth wall portion 14 as much as possible. In the illustrated embodiment of the present disclosure, each of sixth mounting grooves 1401 and each of the eighth mounting grooves 1402 include a third slit 14011 extending through the mounting surface 1b, a second flaring groove 14012 in communication with the third slit 14011, and a fourth slit 14013 in communication with the second flaring groove 14012. The third slit 14011, the second flaring slit 14012 and the fourth slit 14013 are arranged in sequence along the first direction A1-A1. That is, the second flaring groove 14012 is located between the third slit 14011 and the fourth slit 14013 in the first direction A1-A1. In the illustrated embodiment of the present disclosure, a width of the second flaring groove 14012 along the third direction A3-A3 is greater than a width of the third slit 14011 along the third direction A3-A3. The width of the second flaring groove 14012 in the third direction A3-A3 is greater than a width of the fourth slit 14013 in the third direction A3-A3.

In the illustrated embodiment of the present disclosure, neither the first mounting groove 1101 nor the third mounting groove 1102 extends through the first wall portion 11 laterally outward. Neither the second mounting groove 1201 nor the fourth mounting groove 1202 extends through the second wall portion 12 laterally outward. Neither the fifth mounting groove 1301 nor the seventh mounting groove 1302 extends through the third wall portion 13 laterally outward. Neither the sixth mounting groove 1401 nor the eighth mounting groove 1402 extends through the fourth wall portion 14 laterally outward. With this arrangement, the present disclosure can reduce the openings as much as possible, improve the shielding effect, and improve the quality of signal transmission.

Referring to FIG. 13 to FIG. 35, in the illustration embodiment of the present disclosure, the shielding assembly 2 includes a plurality first shielding plate assemblies 21 and a plurality of second shielding plate assemblies 22 which are alternately arranged along the second direction A2-A2, and a plurality of third shielding plate assemblies 23 and a plurality of fourth shielding plate assemblies 24 which are alternately arranged along the third direction A3-A3. The first shielding plate assemblies 21 and the second shielding plate assemblies 22 are inserted with the third shielding plate assemblies 23 and the fourth shielding plate assemblies 24 to form a plurality of shielding units 20 which are arranged generally in a matrix. The terminal modules 3 are installed in corresponding shielding units 20. It is understandable to those skilled in the art that the technical term “matrix” used in the present disclosure should be understood in a broad sense, that is, that is, it should include arrangements that are not arranged in rows or columns due to processes or slight deformations.

Specifically, in the illustrated embodiment of the present disclosure, the first shielding plate assembly 21 includes a first metal plate 211 and a first metal shrapnel 212 fixed to the first metal plate 211. In the illustrated embodiment of the present disclosure, the first metal shrapnel 212 is soldered, welded or riveted to at least an inner side of the first metal plate 211.

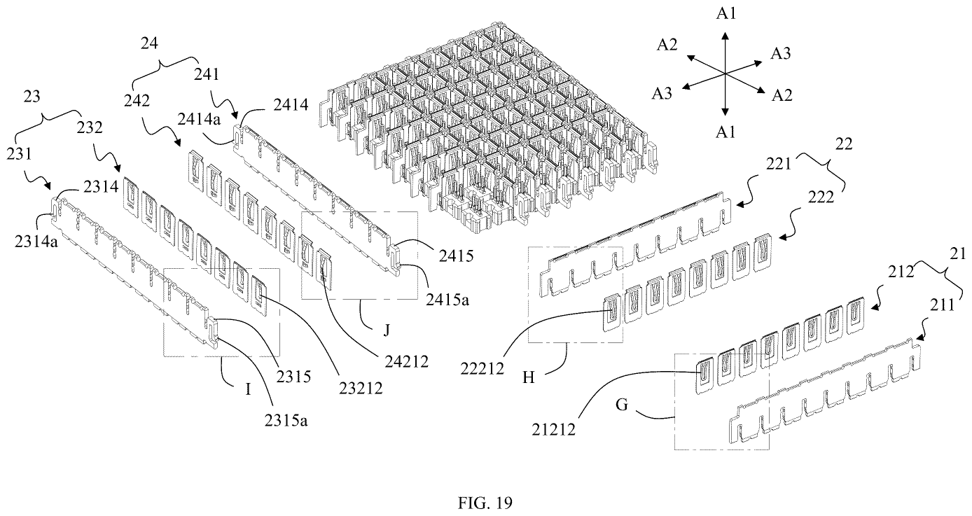

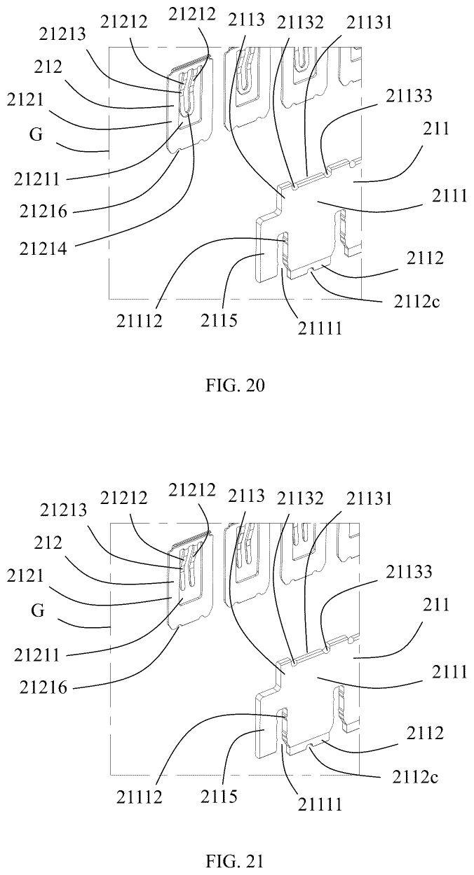

Referring to FIG. 19 and FIG. 20, the first metal plate 211 includes a first main body portion 2111, a plurality of first soldering portions 2112 extending downwardly from the first main body portion 2111 in the first direction A1-A1, a first extension portion 2113 extending integrally from the first main body portion 2111 in the first direction A1-A1, a first mounting portion 2114 connected to the first main body portion 2111 and disposed at one end of the first metal plate 211 along the third direction A3-A3, and a second mounting portion 2115 connected to the first main body portion 2111 and disposed at another end of the first metal plate 211 in the third direction A3-A3. The first main body portion 2111 defines a plurality of first retaining grooves 21111 that extend downwardly through the first main body portion 2111. The first main body portion 2111 includes a plurality of first interference protrusions 21112 disposed at intervals along the first direction A1-A1 and protruding into the first retaining groove 21111. By providing the first interference protrusion 21112, it is beneficial to increase the interference force.

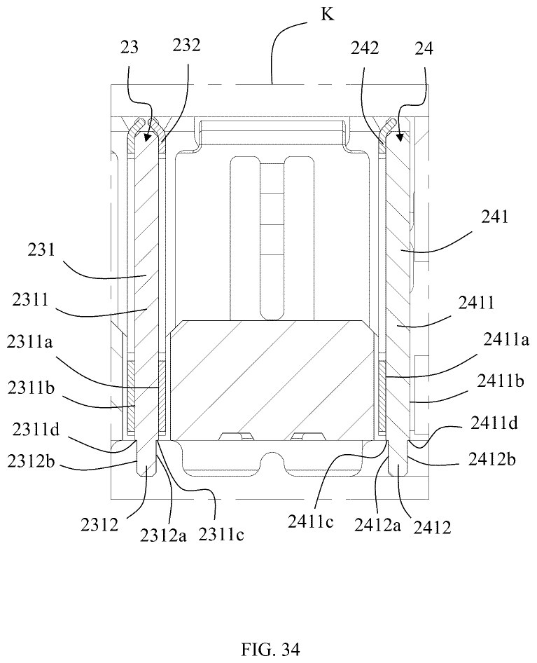

Referring to FIG. 19, FIG. 20 and FIG. 34, in the illustrated embodiment of the present disclosure, the first soldering portion 2112 is thinner than the first main body portion 2111. Specifically, the first main body portion 2111 includes a first inner side surface 2111a and a first outer side surface 2111b disposed opposite to the first inner side surface 2111a. A distance between the first inner side surface 2111a and the first outer side surface 2111b is a thickness of the first main body portion 2111. The first soldering portion 2112 includes a first inner surface 2112a and a first outer surface 2112b disposed opposite to the first inner surface 2112a. A distance between the first inner surface 2112a and the first outer surface 2112b is a thickness of the first soldering portion 2112. In a thickness direction of the first metal plate 211, the first inner surface 2112a is located outside the first inner surface 2111a. In other words, the first metal plate 211 includes a first step surface 2111c located between the first inner surface 2112a and the first inner side surface 2111a. In the thickness direction of the first metal plate 211, the first outer surface 2112b is located inside the first outer side surface 2111b. In other words, the first metal plate 211 includes a second step surface 2111d between the first outer surface 2112b and the first outer side surface 2111b. By providing the first step surface 2111c and/or the second step surface 2111d, it is helpful to reduce the risk of tin creeping during soldering, improve soldering quality, and reduce the probability of short circuit. Referring to FIG. 20, in the illustration embodiment of the present disclosure, the first soldering portion 2112 defines a first ventilation groove 2112c located at a bottom thereof. When the first electrical connector 100 goes through a reflow soldering furnace, heat can be transferred to the intermediate area of the first electrical connector 100, thereby allowing the entire area to be heated evenly and improving the soldering quality.

The first extension portion 2113 defines a first notch 21131 recessed downwardly in the first direction A1-A1, a first groove 21132 located on one side of the first notch 21131 along the third direction A3-A3, and a second groove 21133 located on another side of the first notch 21131 along the third direction A3-A3. The first groove 21132 and the second groove 21133 are both generally arc-shaped, and are in communication with the first notch 21131.

The first metal shrapnel 212 includes a first base portion 2121 and a first protrusion 2122 extending upwardly beyond the first base portion 2121 along the first direction A1-A1. The first base portion 2121 includes a first opening 21211 extending through the first base portion 2121 along a thickness direction of the first base portion 2121, and a first abutment elastic arm 21212 protruding into the first opening 21211 along the first direction A1-A1. A root of the first abutment elastic arm 21212 extends integrally with the first base portion 2121 or the first protrusion 2122. Another end of the first abutment elastic arm 21212 disposed opposite to the root is a movable end. In other words, the first abutment elastic arm 21212 extends from top to bottom along the first direction A1-A1. In this way, on the one hand, the first abutment elastic arm 21212 can guide the second electrical connector 200 when it is inserted into the first electrical connector 100. On the other hand, the insertion force of the second electrical connector 200 can also be reduced. The first abutment elastic arm 21212, when it is in a free state, includes a first abutting portion 21213 protruding from the first base portion 2121 along the thickness direction of the first base portion 2121.

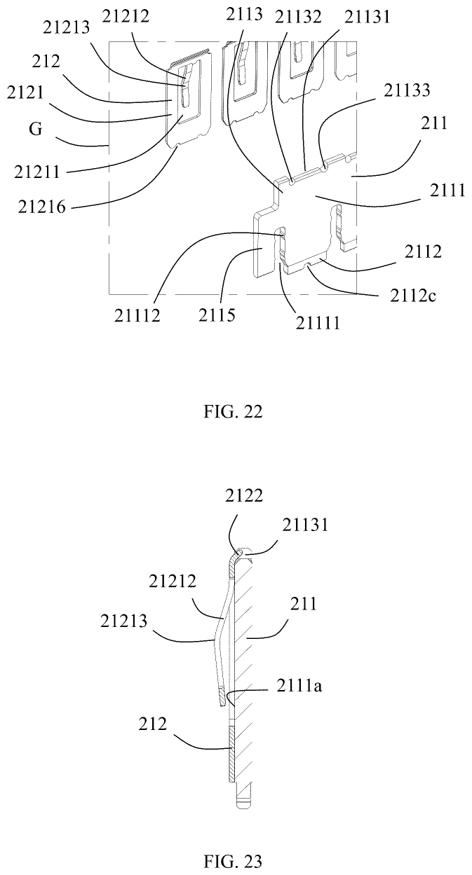

Referring to FIG. 22, in a first embodiment of the present disclosure, corresponding to a first opening 21211, one first abutment elastic arm 21212 is provided.

Referring to FIG. 21, in a second embodiment of the present disclosure, corresponding to a first opening 21211, two first abutment elastic arms 21212 are provided, and the movable ends of the two first abutment elastic arms 21212 are separated from each other.

Referring to FIG. 20, in a third embodiment of the present disclosure, corresponding to a first opening 21211, two first abutment elastic arms 21212 are provided, and the first base portion 2121 includes a first connecting portion 21214 connecting the movable ends of the two first abutting arms 21212 together.

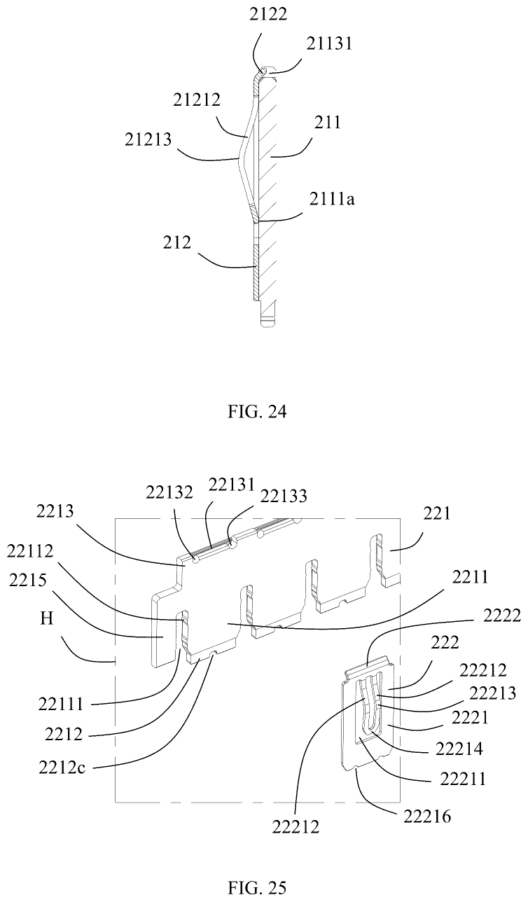

Referring to FIG. 24, in one embodiment of the present disclosure, in a free state, the movable end of the first abutment elastic arm 21212 abuts against the first inner side surface 2111a of the first metal plate 211, that is, the first abutment elastic arm 21212 is a simple support beam. It is understandable to those skilled in the art that by designing the first abutment elastic arm 21212 as a simple support beam, it is beneficial to increasing the plugging and unplugging force of the second electrical connector 200, improving mating reliability, and effectively reducing resonance problems. Of course, in other embodiments of the present disclosure, the first abutment elastic arm 21212 which is a simple support beam may have two ends as fixed ends.

Referring to FIG. 23, in another embodiment of the present disclosure, in the free state, the movable end of the first abutment elastic arm 21212 does not abut against the first inner side surface 2111a of the first metal plate 2111, that is, the first abutment elastic arm 21212 is a cantilever beam. It is understandable to those skilled in the art that by designing the first abutment elastic arm 21212 as a cantilever beam, it is beneficial to reducing the plugging and unplugging force of the second electrical connector 200, thereby facilitating the insertion of the second electrical connector 200. When the second electrical connector 200 is inserted, the first abutting portion 21213 of the first abutment elastic arm 21212 is pressed against by the second electrical connector 200 to be elastically deformed. At this time, the movable end of the first abutment elastic arm 21212 abuts against the first inner side surface 2111a of the first metal plate 211 to form a simple support beam, so that the resonance problem can be reduced.

In the illustrated embodiment of the present disclosure, the first base portion 2121 defines a plurality of first recesses 21216 along a bottom of the first direction A1-A1. The bottom of the first base portion 2121 is approximately flush with a bottom of the first main body portion 2111. The first soldering portion 2112 protrudes downwardly from the first direction A1-A1.

In the illustrated embodiment of the present disclosure, a width of the first protrusion 2122 in the third direction A3-A3 is smaller than a width of the first base portion 2121 in the third direction A3-A3. The first protrusion 2122 is deflected to form a guide surface, and the first protrusion 2122 is at least partially accommodated in the first notch 21131.

Referring to FIG. 25, specifically, in the illustration embodiment of the present disclosure, the second shielding plate assembly 22 includes a second metal plate 221 and a second metal shrapnel 222 fixed to the second metal plate 221. In the illustrated embodiment of the present disclosure, the second metal shrapnel 222 is soldered, welded or riveted to at least an inner side of the second metal plate 221.

The second metal plate 221 includes a second main body portion 2211, a plurality of second soldering portions 2212 extending downwardly from the second main body portion 2211 in the first direction A1-A1, a second extension portion 2213 extending integrally from the second main body portion 2211 along the first direction A1-A1, a third mounting portion 2214 connected to the second main body portion 2211 and located at one end of the second metal plate 221 in the third direction A3-A3, and a fourth mounting portion 2215 connected to the second main body portion 2211 and located at another end of the second metal plate 221 in the third direction A3-A3. The second main body portion 2211 defines a plurality of second retaining grooves 22111 that extend downwardly through the second main body portion 2211. The second main body portion 2211 includes a plurality second interference protrusions 22112 that are disposed at intervals along the first direction A1-A1 and protrude into the second retaining groove 22111. By providing the second interference protrusion 22112, it is beneficial to increase the interference force.

Referring to FIG. 34, in the illustrated embodiment of the present disclosure, the second soldering portion 2212 is thinner than the second main body portion 2211. Specifically, the second main body portion 2211 includes a second inner side surface 2211a and a second outer side surface 2211b disposed opposite to the second inner side surface 2211a. A distance between the second inner side surface 2211a and the second outer side surface 2211b is a thickness of the second main body portion 2211. The second soldering portion 2212 includes a second inner surface 2212a and a second outer surface 2212b disposed opposite to the second inner surface 2212a. A distance between the second inner surface 2212a and the second outer surface 2212b is a thickness of the second soldering portion 2212. In a thickness direction of the second metal plate 221, the second inner surface 2212a is located outside the second inner surface 2211a. In other words, the second metal plate 221 includes a third step surface 2211c located between the second inner surface 2212a and the second inner side surface 2211a. In a thickness direction of the second metal plate 221, the second outer surface 2212b is located inside the second outer side surface 2211b. In other words, the second metal plate 221 includes a fourth step surface 2211d between the second outer surface 2212b and the second outer side surface 2211b. By providing the third step surface 2211c and/or the fourth step surface 2211d, it is helpful to reduce the risk of tin creeping during soldering, improve soldering quality, and reduce the probability of short circuit. Referring to FIG. 25, in the illustration embodiment of the present disclosure, the second soldering portion 2212 defines a second ventilation groove 2212c located at a bottom thereof. When the first electrical connector 100 goes through a reflow soldering furnace, heat can be transferred to the intermediate area of the first electrical connector 100, thereby allowing the entire area to be heated evenly and improving the soldering quality.

The second extension portion 2213 defines a second notch 22131 recessed downwardly in the first direction A1-A1, a third groove 22132 located on one side of the second notch 22131 along the third direction A3-A3, and a fourth groove 22133 located on another side of the second notch 22131 along the third direction A3-A3. The third groove 22132 and the fourth groove 22133 are both generally arc-shaped, and are in communication with the second notch 22131.

The second metal shrapnel 222 includes a second base portion 2221 and a second protrusion 22222 that protrudes upwardly along the first direction A1-A1. The second base portion 2221 includes a second opening 22211 extending through the second base portion 2221 along a thickness direction of the second base portion 2221, and a second abutment elastic arm 22212 protruding into the second opening 22211 in the first direction A1-A1. A root of the second abutment elastic arm 22212 extends integrally with the second base portion 2221 or the second protrusion 2222. Another end on the second abutment elastic arm 22212 disposed opposite to the root is a movable end. In other words, the second abutment elastic arm 22212 extends from top to bottom in the first direction A1-A1. In this way, on the one hand, the second abutment elastic arm 22212 can guide the second electrical connector 200 when it is inserted into the first electrical connector 100. On the other hand, the insertion force of the second electrical connector 200 can also be reduced. The second abutment elastic arm 22212, when it is in a free state, includes a second abutment portion 22213 protruding from the second base portion 2221 in the thickness direction of the second base portion 2221.

Referring to the first metal shrapnel 212 in the three embodiments as shown in FIG. 20 to FIG. 22, it is understandable to those skilled in the art that in the first embodiment of the disclosure, corresponding to a second opening 22211, one second abutment elastic arm 22212 is provided. In the second embodiment of the present disclosure, corresponding to a second opening 22211, two second abutment elastic arms 22212 are provided, and the movable ends of the two second abutment elastic arms 22212 are separated from each other. In the third embodiment of the present disclosure, corresponding to a second opening 22211, two second abutment elastic arms 22212 are provided, and the second base portion 2221 is provided with a second connecting portion 22214 connecting the movable ends of the two second abutment elastic arms 22212 together.

Referring to the first shielding plate assembly 21 in the two embodiments as shown in FIG. 23 and FIG. 24, in a first embodiment of the present disclosure, in the free state, the movable end of the second abutment elastic arm 22212 abuts against the second inner side surface 2211a of the second metal plate 2211, that is, the second abutment elastic arm 22212 is a simple support beam. It is understandable to those skilled in the art that by designing the second abutment elastic arm 22212 as a simple support beam, it is beneficial to increasing the plugging and unplugging force of the second electrical connector 200, improving mating reliability, and effectively reducing resonance problems. Of course, in other embodiments of the present disclosure, the second elastic abutment elastic arm 22212 which is a simple support beam may have two ends as fixed ends.

In another embodiment of the present disclosure, in the free state, the movable end of the second abutment elastic arm 22212 does not abut against the second inner side surface 2211a of the second metal plate 221, that is, the second abutment elastic arm 22212 is a cantilever beam. It is understandable to those skilled in the art, by designing the second abutment elastic arm 22212 as a cantilever beam, it is beneficial to reducing the plugging and unplugging force of the second electrical connector 200, thereby facilitating the insertion of the second electrical connector 200. When the second electrical connector 200 is inserted, the second abutment portion 22213 of the second abutment elastic arm 22212 is pressed against by the second electrical connector 200 and elastically deformed. At this time, the movable end of the second abutment elastic arm 22212 abuts against the second inner side surface 2211a of the second metal plate 221 to form a simple support beam, so that the resonance problem can be reduced.

In the illustrated embodiment of the present disclosure, the second base portion 2221 defines a plurality of second recesses 22216 along a bottom of the first direction A1-A1. The bottom of the second base portion 2221 is approximately flush with a bottom of the second main body portion 2211. The second soldering portion 2212 protrudes downwardly from the second base portion 2221 along the first direction A1-A1.

In the illustrated embodiment of the present disclosure, a width of the second protrusion 2222 along the third direction A3-A3 is smaller than a width of the second base portion 2221 along the third direction A3-A3. The second protrusion 2222 is deflected to form a guide surface, and the second protrusion 2222 is at least partially accommodated in the second notch 22131.

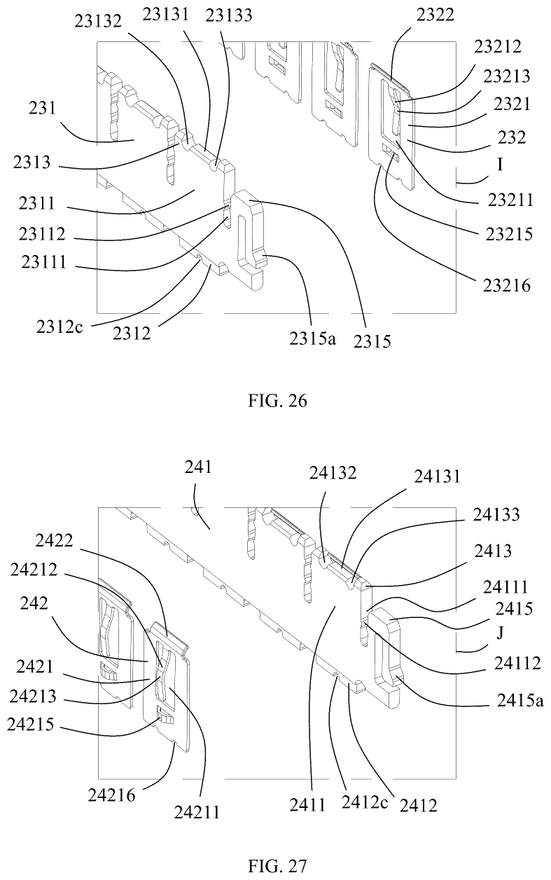

Referring to FIG. 26, specifically, in the illustration embodiment of the present disclosure, the third shielding plate assembly 23 includes a third metal plate 231 and a third metal shrapnel 232 fixed to the third metal plate 231. In the illustrated embodiment of the present disclosure, the third metal shrapnel 232 is soldered, welded or riveted to at least an inner side of the third metal plate 231.

The third metal plate 231 includes a third main body portion 2311, a plurality of third soldering portions 2312 extending downwardly from the third main body portion 2311 in the first direction A1-A1, a third extension portion 2313 extending integrally from the third main body portion 2311 along the first direction A1-A1, a fifth mounting portion 2314 connected to the third main body portion 2311 and located at one end of the third metal plate 231 in the third direction A3-A3, and a sixth mounting portion 2315 connected to the third main body portion 2311 and located at another end of the third metal plate 231 in the third direction A3-A3. In the illustrated embodiment of the present disclosure, the fifth mounting portion 2314 is provided with a first locking elastic arm 2314a. The sixth mounting portion 2315 is provided with a second locking elastic arm 2315a. The first locking elastic arm 2314a and the second locking elastic arm 2315a are both configured to lock with the mounting frame 1 to prevent the shielding assembly 2 from falling off the mounting frame 1. The third main body portion 2311 defines a plurality of third retaining grooves 23111 that extend upwardly through the third main body portion 2311. The third main body portion 2311 includes a plurality of third interference protrusions 23112 which are disposed at intervals along the first direction A1-A1 and protrude into the third retaining groove 23111. By providing the third interference protrusion 23112, it is beneficial to increase the interference force.

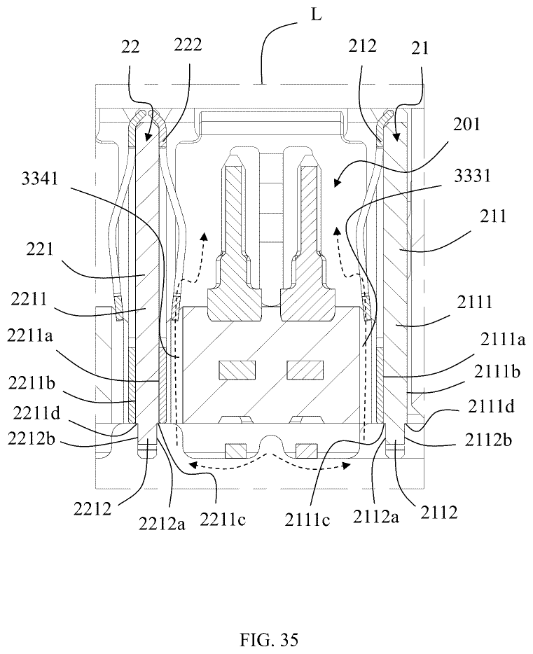

Referring to FIG. 35, in the illustration embodiment of the present disclosure, the third soldering portion 2312 is thinner than the third main body portion 2311. Specifically, the third main body portion 2311 includes a third inner side surface 2311a and a third outer side surface 2311b disposed opposite to the third inner side surface 2311a. A distance between the third inner side surface 2311a and the third outer side surface 2311b is a thickness of the third main body portion 2311. The third soldering portion 2312 includes a third inner surface 2312a and a third outer surface 2312b disposed opposite to the third inner surface 2312a. A distance between the third inner surface 2312a and the third outer surface 2312b is a thickness of the third soldering portion 2312. In a thickness direction of the third metal plate 231, the third inner surface 2312a is located outside the third inner surface 2311a. In other words, the third metal plate 231 includes a fifth step surface 2311c located between the third inner surface 2312a and the third inner side surface 2311a. In a thickness direction of the third metal plate 231, the third outer surface 2312b is located inside the third outer side surface 2311b. In other words, the third metal plate 231 includes a sixth step surface 2311d between the third outer surface 2312b and the third outer side surface 2311b. By providing the fifth step surface 2311c and/or the sixth step surface 2311d, it is beneficial to reduce the risk of tin creeping during soldering, improve soldering quality, and reduce the probability of short circuit. In the illustrated embodiment of the present disclosure, the third soldering portion 2312 defines a third ventilation groove 2312c located at a bottom thereof. When the first electrical connector 100 goes through a reflow soldering furnace, heat can be transferred to the intermediate area of the first electrical connector 100, thereby allowing the entire area to be heated evenly and improving the soldering quality.

The third extension portion 2313 defines a third notch 23131 recessed downwardly along the first direction A1-A1, a fifth groove 23132 located on one side of the third notch 23131 along the third direction A3-A3, and a sixth groove 23133 located on another side of the third notch 23131 along the third direction A3-A3. The fifth groove 23132 and the sixth groove 23133 are both generally arc-shaped, and are in communication with the third notch 23131.

The third metal shrapnel 232 includes a third base portion 2321 and a third protrusion 2322 that protrudes upwardly along the first direction A1-A1. The third base portion 2321 includes a third opening 23211 that extends through the third base portion 2321 in a thickness direction of the third base portion 2321, and a third abutment elastic arm 23212 that protrudes into the third opening 23211 in the first direction A1-A1. A root of the third abutment elastic arm 23212 extends integrally with the third base portion 2321 or the third protrusion 2322. Another end on the third abutment elastic arm 23212 disposed opposite to the root is a movable end. In other words, the third abutment elastic arm 23212 extends from top to bottom along the first direction A1-A1. In this way, the third abutment elastic arm 23212 can, on the one hand, guide the second electrical connector 200 when it is inserted into the first electrical connector 100. On the other hand, the insertion force of the second electrical connector 200 can also be reduced. The third abutment elastic arm 23212, when it is in a free state, includes a third abutment portion 23213 protruding from the third base portion 2321.

Referring to the first metal shrapnel 212 in the three embodiments as shown in FIG. 20 to FIG. 22, it is understandable to those skilled in the art that in the first embodiment of the present disclosure, corresponding to a third opening 23211, one the third abutment elastic arm 23212 is provided. In the second embodiment of the present disclosure, corresponding to a third opening 23211, two third abutment elastic arms 23212 are provided, and the movable ends of the two third abutment elastic arms 23212 are separated from each other. In the third embodiment of the present disclosure, corresponding to a third opening 23211, two third abutment elastic arms 23212 are provided, and the third base portion 2321 is provided with a third connecting portion connecting the movable ends of the two third abutment elastic arms 23212 together.

Referring to the first metal shrapnel 212 in the two embodiments as shown in FIG. 23 and FIG. 24, in one illustrated embodiment of the present disclosure, in the free state, the movable end of the third abutment elastic arm 23212 abuts against the third inner side surface 2311a of the third metal plate 231, that is, the third abutment elastic arm 23212 is a simple support beam. It is understandable to those skilled in the art that by designing the third abutment elastic arm 23212 as a simple support beam, it is beneficial to increasing the plugging and unplugging force of the second electrical connector 200, improving docking reliability, and effectively reducing resonance problems. Of course, in other embodiments of the present disclosure, the third abutment elastic arm 23212 which is a simple support beam may have two ends as fixed ends.

In another embodiment of the present disclosure, in the free state, the movable end of the third abutment elastic arm 23212 does not abut against the third inner side surface 2311a of the third metal plate 231, that is, the third abutment elastic arm 23212 is a cantilever beam. It is understandable to those skilled in the art that by designing the third abutment elastic arm 23212 in the form of a cantilever beam, it will help reduce the plugging and pulling force of the second electrical connector 200 and facilitate insertion of the second electrical connector 200. When the second electrical connector 200 is inserted, the third abutment portion 23213 of the third abutment elastic arm 23212 is pressed against by the second electrical connector 200 and elastically deformed. At this time, the movable end of the third abutment elastic arm 23212 abuts against the third inner side surface 2311a of the third metal plate 231 to form a simple support beam, so that the resonance problem can be reduced.

In one embodiment of the present disclosure, the third base portion 2321 is further provided with a first limiting protrusion 23215 formed by integrally stamping the third base portion 2321.

In the illustrated embodiment of the present disclosure, the third base portion 2321 defines a plurality of third recesses 23216 along a bottom of the first direction A1-A1. The bottom of the third base portion 2321 is approximately flush with a bottom of the third main body portion 2311. The third soldering portion 2312 protrudes downwardly from the third base portion 2321 along the first direction A1-A1.

In the illustrated embodiment of the present disclosure, a width of the third protrusion 2322 along the third direction A3-A3 is smaller than a width of the third base 2321 along the third direction A3-A3. The third protrusion 2322 is deflected to form a guide surface, and the third protrusion 2322 is at least partially accommodated in the third notch 23131.

Referring to FIG. 27, similarly, in the illustration embodiment of the present disclosure, the fourth shielding plate assembly 24 includes a fourth metal plate 241 and a fourth metal shrapnel 242 fixed to the fourth metal plate 241. In the illustrated embodiment of the present disclosure, the fourth metal shrapnel 242 is soldered, welded or riveted to at least an inner side of the fourth metal plate 241.

The fourth metal plate 241 includes a fourth main body portion 2411, a plurality of fourth soldering parts 2412 extending downwardly from the fourth main body portion 2411 in the first direction A1-A1, a fourth extension portion 2413 extending integrally from the fourth main body portion 2411 along the first direction A1-A1, a seventh mounting portion 2414 connected to the fourth main body portion 2411 and located at one end of the fourth metal plate 241 in the third direction A3-A3, and an eighth mounting portion 2415 connected to the fourth main body portion 2411 and located at another end of the fourth metal plate 241 in the third direction A3-A3. In the illustrated embodiment of the present disclosure, the seventh mounting portion 2414 is provided with a third locking elastic arm 2414a. The eighth mounting portion 2415 is provided with a fourth locking elastic arm 2415a. The third locking elastic arm 2414a and the fourth locking elastic arm 2415a are both configured to lock with the mounting frame 1 to prevent the shielding assembly 2 from falling off the mounting frame 1. The fourth main body portion 2411 defines a plurality of fourth retaining grooves 24111 that extend upwardly through the fourth main body portion 2411. The fourth main body portion 2411 includes a plurality of fourth interference protrusions 24112 which are disposed at intervals along the first direction A1-A1 and protrude into the fourth retaining groove 24111. By providing the fourth interference protrusion 24112, it is beneficial to increase the interference force.

The fourth metal plate 241 includes a fourth main body portion 2411, a plurality of fourth soldering parts 2412 extending downwardly from the fourth main body portion 2411 in the first direction A1-A1, a fourth extension portion 2413 extending integrally from the fourth main body portion 2411 along the first direction A1-A1, a seventh mounting portion 2414 connected to the fourth main body portion 2411 and located at one end of the fourth metal plate 241 in the third direction A3-A3, and an eighth mounting portion 2415 connected to the fourth main body portion 2411 and located at another end of the fourth metal plate 241 in the third direction A3-A3. In the illustrated embodiment of the present disclosure, the seventh mounting portion 2414 is provided with a third locking elastic arm 2414a. The eighth mounting portion 2415 is provided with a fourth locking elastic arm 2415a. The third locking elastic arm 2414a and the fourth locking elastic arm 2415a are both configured to lock with the mounting frame 1 to prevent the shielding assembly 2 from falling off the mounting frame 1. The fourth main body portion 2411 defines a plurality of fourth retaining grooves 24111 that extend upwardly through the fourth main body portion 2411. The fourth main body portion 2411 includes a plurality of fourth interference protrusions 24112 which are disposed at intervals along the first direction A1-A1 and protrude into the fourth retaining groove 24111. By providing the fourth interference protrusion 24112, it is beneficial to increase the interference force. When the first electrical connector 100 goes through a reflow soldering furnace, heat can be transferred to the intermediate area of the first electrical connector 100, thereby allowing the entire area to be heated evenly and improving the soldering quality.

The fourth extension portion 2413 defines a fourth notch 24131 recessed downwardly in the first direction A1-A1, a seventh groove 24132 located on one side of the fourth notch 24131 along the third direction A3-A3, and an eighth groove 24133 located on another side of the fourth notch 24131 along the third direction A3-A3. The seventh groove 24132 and the eighth groove 24133 are both generally arc-shaped, and are in communication with the fourth notch 24131.

The fourth metal shrapnel 242 includes a fourth base portion 2421 and a fourth protrusion 2422 that protrudes upwardly along the first direction A1-A1. The fourth base portion 2421 includes a fourth opening 24211 that extends through the fourth base portion 2421 in a thickness direction of the fourth base portion 2421, and a fourth abutment elastic arm 24212 that protrudes into the fourth opening 24211 in the first direction A1-A1. A root of the fourth abutment elastic arm 24212 extends integrally with the fourth base portion 2421 or the fourth protrusion 2422. Another end on the fourth abutment elastic arm 24212 disposed opposite to the root is a movable end. In other words, the fourth abutment elastic arm 24212 extends from top to bottom in the first direction A1-A1. In this way, on the one hand, the fourth abutment elastic arm 24212 can guide the second electrical connector 200 when it is inserted into the first electrical connector 100. On the other hand, the insertion force of the second electrical connector 200 can also be reduced. The fourth abutment elastic arm 24212, when it is in a free state, includes a fourth abutment portion 24213 protruding from the fourth base portion 2421 in the thickness direction of the fourth base portion 2421.

Referring to the first metal shrapnel 212 in the three embodiments as shown in FIG. 20 to FIG. 22, it is understandable to those skilled in the art that in the first embodiment of the disclosure, corresponding to a fourth opening 24211, one fourth abutment elastic arm 24212 is provided. In the second embodiment of the present disclosure, corresponding to a fourth opening 24211, two fourth abutment elastic arms 24212 are provided, and the movable ends of the two fourth abutment elastic arms 24212 are separated from each other. In the third embodiment of the present disclosure, corresponding to a fourth opening 24211, two fourth abutment elastic arms 24212 are provided, and the fourth base portion 2421 is provided with a fourth connecting portion connecting the movable ends of the two fourth abutment elastic arms 24212 together.

Referring to the first shielding plate assembly 21 in the two embodiments as shown in FIG. 23 and FIG. 24, in a first embodiment of the present disclosure, in the free state, the movable end of the fourth abutment elastic arm 24212 abuts against the fourth inner side surface 2411a of the fourth metal plate 241, that is, the fourth abutment elastic arm 24212 is a simple support beam. It is understandable to those skilled in the art that by designing the fourth abutment elastic arm 24212 in the form of a simple support beam, it will help increase the plugging and pulling force of the second electrical connector 200, improve docking reliability, and effectively reduce resonance problems. Of course, in other embodiments of the present disclosure, two ends of the fourth abutment elastic arm 24212 which is a simple support beam may be fixed ends.

In another embodiment of the present disclosure, in a free state, the movable end of the fourth abutment elastic arm 24212 does not abut against the fourth inner side surface 2411a of the fourth metal plate 241, that is, the fourth abutment elastic arm 24212 is a cantilever beam. It is understandable to those skilled in the art that by designing the fourth abutment elastic arm 24212 in the form of a cantilever beam, it will help reduce the plugging and pulling force of the second electrical connector 200 and facilitate insertion of the second electrical connector 200. When the second electrical connector 200 is inserted, the fourth abutment portion 24213 of the fourth abutment elastic arm 24212 is pressed against by the second electrical connector 200 and elastically deformed. At this time, the movable end of the fourth abutment elastic arm 24212 abuts against the fourth inner side surface 2411a of the fourth metal plate 241 to form a simple support beam, so that the resonance problem can be reduced.

In one embodiment of the present disclosure, the fourth base portion 2421 is also provided with a second limiting protrusion 24215 formed by integrally stamping the fourth base portion 2421.

In the illustration embodiment of the present disclosure, the fourth base portion 2421 defines a plurality of fourth notches 24216 along a bottom of the first direction A1-A1. The bottom of the fourth base portion 2421 is approximately flush with a bottom of the fourth main body 2411. The fourth soldering portion 2412 protrudes downwardly beyond the fourth base portion 2421 along the first direction A1-A1.

In the illustrated embodiment of the present disclosure, a width of the fourth protrusion 2422 in the third direction A3-A3 is smaller than a width of the fourth base portion 2421 in the third direction A3-A3. The fourth protrusion 2422 is deflected to form a guide surface, and the fourth protrusion 2422 is at least partially accommodated in the fourth notch 24131.

When assembling the shielding assembly 2, the first shielding plate assembly 21 and the second shielding plate assembly 22 are inserted with the third shielding plate assembly 23 and the fourth shielding plate assembly 24. Specifically, the plurality of first retaining grooves 21111 of the first shielding plate assembly 21 correspond to the third retaining grooves 23111 of the third shielding plate assembly 23 and the fourth retaining grooves 24111 of the fourth shielding plate assembly 24. The plurality of second retaining grooves 22111 of the second shielding plate assembly 22 correspond to the third retaining grooves 23111 of the third shielding plate assembly 23 and the fourth retaining grooves 24111 of the fourth shielding plate assembly 24.

Referring to FIG. 13 to FIG. 16, with respect to the shielding assembly 2, in the third direction A3-A3, the first mounting portion 2114 and the second mounting portion 2115 protrude beyond the third shielding piece assembly 23 and the fourth shielding piece assembly 24 to two sides. The third mounting portion 2214 and the fourth mounting portion 2215 protrude beyond the third shielding plate assembly 23 and the fourth shielding plate assembly 24 to two sides. In the second direction A2-A2, the fifth mounting portion 2314 and the sixth mounting portion 2315 protrude beyond the first shielding plate assembly 21 and the second shielding plate assembly 22 to two sides. The seventh mounting portion 2414 and the eighth mounting portion 2415 protrude beyond the first shielding plate assembly 21 and the second shielding plate assembly 22 to two sides.

With respect to one shielding unit 20, it defines an accommodating space 201 which is surrounded by at least part of the first shielding plate assembly 21, at least part of the second shielding plate assembly 22, at least part of the third shielding plate assembly 23, and at least part of the fourth shielding plate assembly 24. The first metal plate 211 and the second metal plate 221 are located on opposite sides of the accommodating space 201, respectively. The third metal plate 231 and the fourth metal plate 241 are located on opposite sides of the accommodating space 201, respectively. The first abutment elastic arm 21212, the second abutment elastic arm 22212, the third abutment elastic arm 23212 and the fourth abutment elastic arm 24212 all protrude into the accommodating space 201. Of course, it is understandable to those skilled in the art that one, two or more abutment elastic arms among the first abutment elastic arm 21212, the second abutment elastic arm 22212, the third abutment elastic arm 23212 and the fourth abutment elastic arm 24212 may be omitted.

In one assembly method disclosed in the present disclosure, when the shielding assembly 2 is assembled with the mounting frame 1, the first mounting portion 2114 is inserted into the first mounting groove 1101 of the first wall portion 11; the second mounting portion 2115 is inserted into the second mounting groove 1201 of the second wall portion 12; the third mounting portion 2214 is inserted into the third mounting groove 1102 of the first wall portion 11; the fourth mounting portion 2215 is inserted into the fourth mounting groove 1202 of the second wall portion 12; the fifth mounting portion 2314 is inserted into the fifth mounting groove 1301 of the third wall portion 13; the sixth mounting portion 2315 is inserted into the sixth mounting groove 1401 of the fourth wall portion 14; the seventh mounting portion 2414 is inserted into the seventh mounting groove 1302 of the third wall portion 13; the eighth mounting portion 2415 is inserted into the eighth mounting groove 1402 of the fourth wall portion 14; the first locking elastic arm 2314a and the third locking elastic arm 2414a are respectively locked in the first flaring groove 13012 corresponding to the third wall portion 13; the second locking elastic arm 2315a and the fourth locking elastic arm 2415a are respectively locked in the second flaring groove 14012 corresponding to the fourth wall portion 14.

In another assembly method disclosed in the present disclosure, the third shielding plate assembly 23 and the fourth shielding plate assembly 24 are first inserted and secured to the mounting frame 1, so that the first locking elastic arm 2314a and the third locking elastic arm 2414a are respectively locked into the first flaring groove 13012 corresponding to the third wall portion 13. The second locking elastic arm 2315a and the fourth locking elastic arm 2415a are respectively locked in the second flaring groove 14012 corresponding to the fourth wall portion 14. Then, the first shielding plate assembly 21 and the second shielding plate assembly 22 are inserted and secured to the mounting frame 1 and are perpendicularly interposed with the third shielding plate assembly 23 and the fourth shielding plate assembly 24.

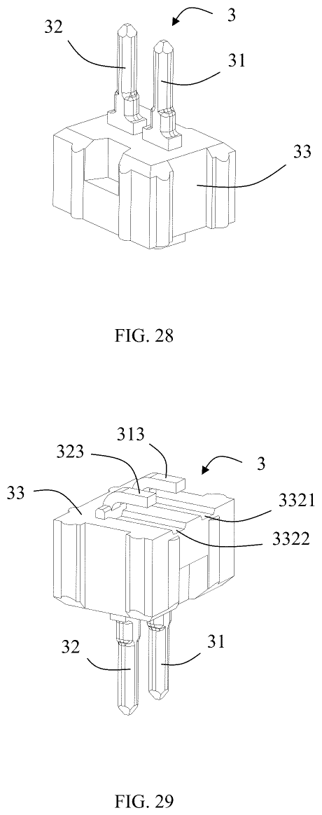

In the illustrated embodiment of the present disclosure, the plurality of terminal modules 3 are the same. Referring to FIG. 28 to FIG. 31, each terminal module 3 includes an insulating block 33, a first conductive terminal 31 secured to the insulating block 33, and a second conductive terminal 32 secured to the insulating block 33. In one embodiment of the present disclosure, the first conductive terminal 31 and the second conductive terminal 32 are insert-molded with the insulating block 33 to be combined into a whole. Of course, it is understandable to those skilled in the art that in other embodiments of the present disclosure, the first conductive terminal 31 and the second conductive terminal 32 may also be secured to the insulating block 33 by other means (for example, by assembly). In one embodiment of the present disclosure, the first conductive terminal 31 and the second conductive terminal 32 form a differential pair to increase the rate of signal transmission.

The insulating block 33 includes a top surface 331, a bottom surface 332, a first side wall 333, a second side wall 334 disposed opposite to the first side wall 333, a third side wall 335, and a fourth side wall 336 disposed opposite to the third side wall 335.

In the illustrated embodiment of the present disclosure, each of the first side wall 333, the second side wall 334, the third side wall 335 and the fourth side wall 336 includes a protruding rib 337 protruding outwards. The protruding ribs 337 are disposed to abut against the corresponding first body portion 2111, the second body portion 2211, the third body portion 2311 and the fourth body portion 2411 so as to increase the holding force.

In the illustrated embodiment of the present disclosure, the first side wall 333 defines a first through groove 3331 extending through the top surface 331 and the bottom surface 332 in the first directions A1-A1. The second side wall 334 defines a second through groove 3341 extending through the top surface 331 and the bottom surface 332 in the first direction A1-A1. By providing the first through groove 3331 and the second through groove 3341, when the first electrical connector 100 goes through a reflow soldering furnace, heat can be transferred to the intermediate area of the first electrical connector 100, thereby allowing the entire area to be heated evenly and improving the soldering quality. The third side wall 335 includes a first mounting opening 3351 that extends upwardly through the top surface 331 along the first direction A1-A1, and a first abutment surface 3352 that is located at a bottom of the first mounting opening 3351. The fourth side wall 336 includes a second mounting opening 3361 that extends upwardly through the top surface 331 along the first direction A1-A1, and a second abutment surface 3362 that is located at a bottom of the second mounting opening 3361. Besides, the insulating block 33 further includes a first slot 3321 and a second slot 3322 which are located on the bottom surface 332. The first slot 3321 and the second slot 3322 both extend along the third direction A3-A3, and both extend through the fourth side wall 336 so as to improve the uniformity of heat distribution and improve soldering quality.

The first conductive terminal 31 includes a first fixing portion 311 secured in the insulating block 33, a first contact portion 312 extending from one end of the first fixing portion 311 and protruding upwardly beyond the insulating block 33, and a first tail portion 313 extending from another end of the first fixing portion 311 and protruding downwardly beyond the insulating block 33. In the illustrated embodiment of the present disclosure, the first contact portion 312 is in a needle shape and protrudes into the accommodating space 201. The first tail portion 313 is substantially in a flat shape and is mounted on the first signal conductive pad SP1 of the circuit board 300 via a surface mounting technology. The first tail portion 313 corresponds to the first slot 3321, but the first tail portion 313 protrudes downwardly beyond the first slot 3321 in the first direction A1-A1.

Similarly, the second conductive terminal 32 includes a second fixing portion 321 secured in the insulating block 33, a second contact portion 322 extending from one end of the second fixing portion 321 and protruding upwardly beyond the insulating block 33, and a second tail portion 323 extending from another end of the second fixing portion 321 and protruding downwardly beyond the insulating block 33. In the illustrated embodiment of the present disclosure, the second contact portion 322 is in a needle shape and protrudes into the accommodating space 201. The second tail portion 323 is generally in a flat shape and is mounted on the second signal conductive pad SP2 of the circuit board 300 via a surface mounting technology. The second tail portion 323 corresponds to the second slot 3322, but the second tail portion 323 protrudes downwardly beyond the second slot 3322 in the first direction A1-A1.

When the terminal module 3 is assembled into a corresponding accommodating space 201 of the shielding assembly 2, the terminal module 3 extends the first directions A1-A1 and is assembled from bottom to top. The first limiting protrusion 23215 is received in the first mounting opening 3351 and abuts against the first abutment surface 3352 to play a limiting role. Similarly, the second limiting protrusion 24215 is received in the second mounting opening 3361 and abuts against the second abutment surface 3362 to play a limiting role. In this way, the first tail portions 313 and the second tail portions 323 of all the terminal modules 3 can be controlled in a same plane, which is conducive to improving the yield of the product.

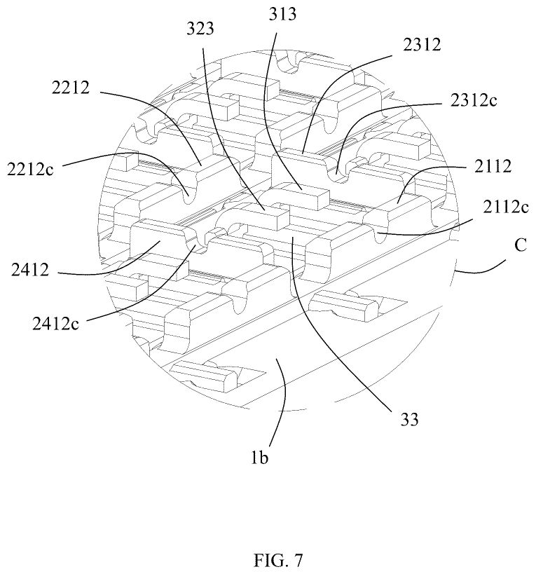

Referring to FIG. 7, when the first electrical connector 100 is assembled, the first soldering portion 2112, the second soldering portion 2212, the third soldering portion 2312 and the fourth soldering portion 2412 all protrude downwardly beyond the mounting surface 1b along the first direction A1-A1. The first soldering portion 2112, the second soldering portion 2212, the third soldering portion 2312 and the fourth soldering portion 2412 are soldered with the first ground conductive pad GP1, the second ground conductive pad GP2, the third ground conductive pad GP3 and the fourth ground conductive pad GP4, respectively.

The first tail portion 313 and the second tail portion 323 are surrounded by the first soldering portion 2112, the second soldering portion 2212, the third soldering portion 2312 and the fourth soldering portion 2412 at heights where the first tail portion 313 and the second tail portion 323 are located, thereby improving the shielding effect.

The first shielding plate assembly 21 is at least partially exposed to the first through groove 3331. The second shielding plate assembly 22 is at least partially exposed to the second through groove 3341. The heat generated during soldering or operation can be discharged outward through the first through groove 3331 and the second through groove 3341, thereby facilitating the improvement of heat dissipation performance.

In addition, during soldering, the first ventilation groove 2112c, the second ventilation groove 2212c, the third ventilation groove 2312c and the fourth ventilation groove 2412c are also conducive for heat distribution. When the first electrical connector 100 goes through a reflow soldering furnace, heat can be transferred to the intermediate area of the first electrical connector 100, thereby allowing the entire area to be heated evenly and improving the soldering quality.

The second electrical connector 200 includes a mating housing 5 and a plurality of metal shielding enclosures 6. The mating housing 5 is provided with a first positioning plate 51 which is located on one side, and a second positioning plate 52 and a third positioning plate 53 which are located on another side. The first positioning plate 51 is configured to be inserted into the first guide groove 1111. The second positioning plate 52 is configured to be inserted into the second guide groove 1211. The third positioning plate 53 is configured to be inserted into the third guide groove 1221.

Besides, the mating housing 5 defines a first assembly hole 54 and a second assembly hole 55. The connector assembly includes a plurality of fasteners that secure the second electrical connector 200 and the first electrical connector 100 together. The fasteners include a third screw 403 and a fourth screw 404. The third screw 403 passes through the first assembly hole 54 and is fixed in the first mounting hole 161 of the first electrical connector 100. The fourth screw 404 passes through the second assembly hole 55 and is fixed in the second mounting hole 162 of the first electrical connector 100.

The metal shielding enclosure 6 is configured to be at least partially inserted into the accommodating space 201 of the first electrical connector 100. The metal shielding enclosure 6 abuts against the first abutment elastic arm 21212 of the first electrical connector 100 and the second abutment elastic arm 22212 of the first electrical connector 100 to increase the plugging and unplugging force and improve the shielding effect.

Compared with the prior art, the shielding assembly 2 of the present disclosure includes the first shielding plate assembly 21, the second shielding plate assembly 22, the third shielding plate assembly 23 and the fourth shielding plate assembly 24. The first shielding plate assembly 21, the second shielding plate assembly 22, the third shielding plate assembly 23 and the fourth shielding plate assembly 24 are interposed to one another to form the plurality of shielding units 20 arranged in a matrix, thereby facilitating the increase in density. The first shielding plate assembly 21, the second shielding plate assembly 22, the third shielding plate assembly 23 and the fourth shielding plate assembly 24 all come into contact with the mounting frame 1, thereby improving the overall shielding effect. In addition, the terminal modules 3 have the same structure, which reduces the cost. Each terminal module 3 is held in the corresponding shielding unit 20 without mating with the mounting frame 1, thereby saving space.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a mounting frame, the mounting frame defining a mounting space;
a shielding assembly, the shielding assembly being at least partially disposed in the mounting space; the shielding assembly comprising a first shielding plate assembly, a second shielding plate assembly, a third shielding plate assembly and a fourth shielding plate assembly; the first shielding plate assembly and the second shielding plate assembly being disposed at intervals in a second direction; the third shielding plate assembly and the fourth shielding plate assembly being disposed at intervals in a third direction; the first shielding plate assembly and the second shielding plate assembly being mated with the third shielding plate assembly and the fourth shielding plate assembly to form a plurality of shielding units; each shielding unit comprising an accommodating space extending in a first direction; each two of the first direction, the second direction and the third direction being perpendicular to each other; and
a terminal module, the terminal module being received in the accommodating space; the terminal module comprising an insulating block; the insulating block comprising a top surface, a bottom surface, and a first through groove extending through the top surface and the bottom surface; the first through groove being in communication with the accommodating space.

2. The electrical connector according to claim 1, wherein the insulating block comprises a first side wall, a second side wall disposed opposite to the first side wall, a third side wall, and a fourth side wall disposed opposite to the third side wall;
the first through groove is provided on the first side wall, and the first through groove is configured to dissipate heat.

3. The electrical connector according to claim 2, wherein the first shielding plate assembly is at least partially exposed to the first through groove.

4. The electrical connector according to claim 2, wherein the second side wall defines a second through groove extending through the top surface and the bottom surface in the first direction; the second through groove is in communication with the accommodating space, and the second through groove is configured to dissipate heat.

5. The electrical connector according to claim 4, wherein the second shielding plate assembly is at least partially exposed to the second through groove.

6. The electrical connector according to claim 2, wherein the first side wall, the second side wall, the third side wall and the fourth side wall are provided with protruding ribs protruding outwards; the protruding ribs abut against corresponding first shielding plate assembly, second shielding plate assembly, third shielding plate assembly and fourth shielding plate assembly.

7. The electrical connector according to claim 2, wherein the terminal module comprises a first conductive terminal secured to the insulating block and a second conductive terminal secured to the insulating block; the first conductive terminal comprises a first tail portion; the second conductive terminal comprises a second tail portion; the first tail portion and the second tail portion are both configured to be soldered to the circuit board;
the insulating block further comprises a first slot and a second slot which are located on the bottom surface; the first slot and the second slot both extend through the fourth side wall;
the first tail portion corresponds to the first slot and protrudes downwardly beyond the first slot along the first direction;
the second tail portion corresponds to the second slot and protrudes downwardly beyond the second slot along the first direction.

8. The electrical connector according to claim 1, wherein the first shielding plate assembly comprises a first metal plate; the first metal plate comprises a first main body portion and a first soldering portion extending from the first main body portion; the first soldering portion is configured to be soldered to the circuit board; the first soldering portion defines a first ventilation groove configured to dissipate heat.

9. The electrical connector according to claim 1, wherein the second shielding plate assembly comprises a second metal plate; the second metal plate comprises a second main body portion and a second soldering portion extending from the second main body portion;
the second soldering portion is configured to be soldered to the circuit board; the second soldering portion defines a second ventilation groove configured to dissipate heat.

10. The electrical connector according to claim 1, wherein the third shielding plate assembly comprises a third metal plate; the third metal plate comprises a third main body portion and a third soldering portion extending from the third main body portion; the third soldering portion is configured to be soldered to the circuit board; the third soldering portion defines a third ventilation groove configured to dissipate heat.

11. The electrical connector according to claim 1, wherein the fourth shielding plate assembly comprises a fourth metal plate; the fourth metal plate comprises a fourth main body portion and a fourth soldering portion extending from the fourth main body portion; the fourth soldering portion is configured to be soldered to the circuit board; the fourth soldering portion defines a fourth ventilation groove configured to dissipate heat.

12. An electrical connector, comprising:
a mounting frame;
a shielding assembly, the shielding assembly being at least partially mounted to the mounting frame; the shielding assembly comprising a first shielding plate assembly, a second shielding plate assembly, a third shielding plate assembly and a fourth shielding plate assembly; the first shielding plate assembly and the second shielding plate assembly being disposed at intervals in a second direction; the third shielding plate assembly and the fourth shielding plate assembly being disposed at intervals in a third direction; the first shielding plate assembly and the second shielding plate assembly being mated with the third shielding plate assembly and the fourth shielding plate assembly to form a plurality of shielding units; each shielding unit comprising an accommodating space extending in a first direction; each two of the first direction, the second direction and the third direction being perpendicular to each other; and
a terminal module, the terminal module being received in the accommodating space; the terminal module comprising an insulating block; the insulating block comprising a first surface, a second surface disposed opposite to the first surface, and a first through groove extending through the first surface and the second surface along the first direction; the first through groove being in communication with the accommodating space.

13. The electrical connector according to claim 12, wherein the insulating block comprises a first side wall, a second side wall disposed opposite to the first side wall, a third side wall, and a fourth side wall disposed opposite to the third side wall;
the first through groove is provided on the first side wall, and the first through groove is configured to dissipate heat.

14. The electrical connector according to claim 13, wherein the first shielding plate assembly is at least partially exposed to the first through groove.

15. The electrical connector according to claim 13, wherein the second side wall defines a second through groove extending through the first surface and the second surface in the first direction; the second through groove is in communication with the accommodating space, and the second through groove is configured to dissipate heat.

16. The electrical connector according to claim 15, wherein the second shielding plate assembly is at least partially exposed to the second through groove.

17. The electrical connector according to claim 13, wherein the first side wall, the second side wall, the third side wall and the fourth side wall are provided with protruding ribs protruding outwards; the protruding ribs abut against corresponding first shielding plate assembly, second shielding plate assembly, third shielding plate assembly and fourth shielding plate assembly.

18. The electrical connector according to claim 13, wherein the terminal module comprises a first conductive terminal secured to the insulating block and a second conductive terminal secured to the insulating block; the first conductive terminal comprises a first tail portion; the second conductive terminal comprises a second tail portion; the first tail portion and the second tail portion are both configured to be soldered to the circuit board;
the insulating block further comprises a first slot and a second slot which are located on the second surface; the first slot and the second slot both extend through the fourth side wall;
the first tail portion corresponds to the first slot and protrudes downwardly beyond the first slot along the first direction;
the second tail portion corresponds to the second slot and protrudes downwardly beyond the second slot along the first direction.

19. The electrical connector according to claim 12, wherein the first shielding plate assembly comprises a first metal plate; the first metal plate comprises a first main body portion and a first soldering portion extending from the first main body portion; the first soldering portion is configured to be soldered to the circuit board; the first soldering portion defines a first ventilation groove configured to dissipate heat.

20. The electrical connector according to claim 12, wherein the second shielding plate assembly comprises a second metal plate; the second metal plate comprises a second main body portion and a second soldering portion extending from the second main body portion; the second soldering portion is configured to be soldered to the circuit board; the second soldering portion defines a second ventilation groove configured to dissipate heat.
